(19) United States
(12) Patent Application Publication
(10) Pub. No.: US 2015/0058272 A1
(43) Pub. Date: Feb. 26, 2015

(54) EVENT CORRELATION DETECTION SYSTEM

(71) Applicant: NEC Corportion, Tokyo (JP)

(72) Inventor: Toshio Tonouchi, Tokyo (JP)

(21) Appl. No.: 14/388,589

(22) PCT Filed: Mar. 8, 2013
(86) PCT No.: PCT/JP2013/001481

§ 371 Date: Sep. 26, 2014

(30) Foreign Application Priority Data
Mar. 26, 2012 (JP) 2012-068639

(51) Int. Cl. G06N 5/02; G06N 7/00

(52) U.S. Cl. CPC G06N 5/027; G06N 7/005
USPC 706/47

(57) ABSTRACT

Disclosed is an event correlation detection system that can automatically set a minimum supporting rate and a minimum reliability rate so that an erroneous detection rate is reduced to an allowable level. The event correlation detection system 101 includes an arrival rate calculation unit 102 calculating an arrival rate, an occurrence probability calculation unit 103 calculating a first probability, a threshold calculation unit 104 calculating the minimum supporting rate and the minimum reliability rate for a dependency rule, and an event association rule engine unit 160 detecting an association among a plurality of event types.

### TECHNICAL FIELD

The present invention relates to a technical field of information processing for detecting an association among events.

### BACKGROUND ART

FIG. 21 is a block diagram depicting a configuration of a typical event correlation detection system. Referring to FIG. 21, the event correlation detection system includes the following units (or apparatus):

an event source 110;

a window division unit 1001;

an event type window table storage unit 1002;

an event association rule engine unit 1003;

a graphical user interface (hereafter abbreviated as “GUI”) 115;

an event history database (hereafter abbreviated as “DB”) storage unit 1004;

an event type window division unit 1005;

an event type window table storage unit 1006;

a rule generation unit 930; and

an event association rule storage unit 1008.

Patent Literature 1 discloses an example of rule generation technique in the event correlation detection system depicted in FIG. 21. FIG. 22 is a diagram illustrating an example of the rule generation technique in the event correlation detection system exemplary depicted in FIG. 21. Referring to FIG. 22, the rule generation technique includes a mining kernel interface function 26, a mining kernel function 16, and a mining result recording function 28 storing an execution result of the mining kernel.

The following describes an operation performed by an event association rule generation system that includes rule generation technique as described above.

The event history DB storage unit 1004 stores a history associated with an event caused by the event source 110. FIG. 26 is a diagram schematically illustrating an example of information existing in the event history DB storage unit 1004. The event history DB storage unit 1004 stores an identifier identifying the event (hereafter abbreviated as “ID”) (E#) associated with a time at which the event occurs (a timing, which is an item “TIME” in FIG. 26) and properties regarding the event type or the like.

The event type window division unit 1005 divides the time stored in the event history DB storage unit 1004 into time periods W (sec). As such, the event type window division unit 1005 classifies an event into a set of events (hereafter referred to as an “event type window”) in accordance with a time at which the event occurs. FIG. 23 is a diagram schematically illustrating an example of a state where occurrence of events is classified into the event type window. The horizontal axis in FIG. 23 indicates passage of time that continues in the rightward direction. Triangles in FIG. 23 indicate occurrence of events. As illustrated in FIG. 23, events intermittently occur. The events classified by the event type window division unit 1005 are stored in an event type window table as illustrated in FIG. 24. FIG. 24 is a diagram illustrating a specific example of the event type window table. For at least one ID(E#) of an event that occurs during a time associated with an ID(W#) of a window, the event type window table stores E# associated with W#.

FIG. 25 is a diagram illustrating an example of an image associated with the event type window table. The event type window table stores the ID(W#) of the event type window associated with an event type of an event pertaining to the event type window. The rule generation unit 930 refers to a predetermined threshold given by a user via the GUI 115 and generates an event association rule.

The event source 110 causes an event to occur. The window division unit 1001 stores events that occur during a fixed time period W (sec) in the event type window table storage unit 1002. The event type window table storage unit 1002 further stores the W# associated with an event type of an event that occurs during the W#.

The event association rule engine unit 1003 refers to the event association rule storage unit 1008 and displays events that have an association with each other on the GUI 115 in accordance with processing as described below. For example, a rule that an event having an event type C occurs when an event having an event type A and an event having an event type B occur is expressed in the form of an event association rule “A, B [symbol] C.”

It is assumed that an event E3 having the event type C occurs during a certain event type window W1. Also, it is assumed that an event E1 having the event type A and an event E2 having the event type B exist immediately before occurrence of the event E3 within a period of the event type window W1.

In this case, the event association rule engine unit 1003 decides that the event E3 occurs when the event E1 and the event E2 occur. As a result, the event association rule engine unit 1003 associates events with event types of the events and thus generates the event association rule “A, B [symbol] C.”

The mining kernel function 16 generates an event association rule in accordance with processing as described below. The mining kernel interface function 26 includes information regarding a predetermined minimum supporting rate (or a lowest support rate) and a predetermined minimum reliability rate (or a lowest reliability rate), which provides criteria for decision.

The mining kernel function 16 reads histories regarding events that occurred in the past using a data access program or utility software and analyses association among events based on the read result. The mining kernel function 16 then stores an association rule generated by the analysis in the mining result recording function 28.

It is noted that k represents the number of types of event combinations retained by the mining kernel function 16. The mining kernel function 16 starts from k=2 and increases k by 1 at a time, and then calculates the supporting rate (support rate) (hereafter referred to as a “supporting rate SR”) in accordance with the following equation:

Supporting rate SR=k÷Nw

(It is assumed that event combinations g having k kinds of event types appear in Nw windows out of all the event type windows.)

The mining kernel function 16 increases k by 1 at a time and thus repeats calculation of the above supporting rate SR until the supporting rates SRs for all the event type windows become lower than the predetermined minimum supporting rate. It is noted here that the number of combinations for which the mining kernel function 16 completes the above calculation is represented by h. The mining kernel function 16 presents an event combination including an event type that has the supporting rate SR equal to or larger than the predetermined minimum supporting rate at a point of (h−1).

The mining kernel function 16 then retrieves an event residing in the event type combination presented as described above. The mining kernel function 16 calculates whether or not there is an association with respect to occurrence of the retrieved event in accordance with the following procedure. It is assumed that the presented event type combination is {A, B, C, D}. The mining kernel function 16 retrieves one event type (identified by “D”) therefrom, and finds out whether or not occurrence of the event D has an association with occurrence of the event A, B, or C in accordance with a reliability rate (hereafter referred to as a “reliability rate TR”) which is defined by the following equation.

Reliability rate TR=(the number of event type windows in which {A,B,C,D}occur)÷(the number of event type windows in which {A,B,C}occur)

When the reliability rate TR calculated as described above is equal to or larger than a predetermined minimum reliability rate, the mining kernel function specifies “A, B, C [symbol] D” as the event association rule.

### PRIOR ART LITERATURE

### Patent Literature

[Patent Literature 1] Japanese Patent Publication No. 3195233.

### SUMMARY OF THE INVENTION

### Problems to be Solved by the Invention

A technical problem in the context of Patent Literature 1 is difficulty in appropriately defining the predetermined minimum supporting rate and the predetermined minimum reliability rate. When values of the predetermined minimum supporting rate and the predetermined minimum reliability rate are not properly defined, the mining kernel function 16 may detect an erroneous result indicating that event types which do not actually have an association with each other are treated as having an association. The minimum supporting rate and the minimum reliability rate have been currently obtained to ensure allowable erroneous detection rate by trial and error.

The principal object of the present invention is to provide an event correlation detection system and the like that can automatically set the minimum supporting rate and the minimum reliability rate such that the erroneous detection rate is reduced to an allowable level.

### Means for Solving the Problems

As one aspect of the present invention, an event correlation detection system according to the present invention has the following configuration.

Specifically, the event correlation detection system according to the present invention is characterized for a plurality of event types by including: an arrival rate calculation unit that calculates, for each of the event types, an arrival rate that the event type arrives during a predetermined time period; an occurrence probability calculation unit calculating, for each of the event types, a first probability that the event type occurs, based on the arrival rate and the time period; a threshold calculation unit that calculates a second probability that the plurality of event types occur simultaneously, based on the first probability, and calculates a minimum supporting rate for a combination of the event types and a minimum reliability rate for a dependency rule, based on the second probability; and an event association rule engine unit that detects an association among the plurality of event types in accordance with the minimum supporting rate and the minimum reliability rate.

As another aspect of the present invention, an event correlation detection method of the present invention is characterized for a plurality of event types by including: calculating, for each of the event types, an arrival rate that the event type arrives during a predetermined time period; calculating, for each of the event types, a first probability that the event type occurs, based on the arrival rate and the time period; calculating a second probability that the plurality of event types occur simultaneously, based on the first probability, and calculating a minimum supporting rate for an event type combination and a minimum reliability rate for a dependency rule based on the second probability; and detecting an association among the plurality of event types in accordance with the minimum supporting rate and the minimum reliability rate.

The object may also be attained by using a computer program, as well as a computer-readable recording medium storing the computer program, to cause a computer to implement an event correlation detection apparatus having the above configuration and a corresponding method.

### Effect of the Invention

An event correlation detection system according to the present invention makes it possible to reduce an erroneous detection rate to an allowable level.

### BRIEF DESCRIPTION OF THE DRAWINGS

FIG. 1 is a block diagram illustrating a configuration of an event correlation detection system according to a first exemplary embodiment of the present invention,

FIG. 2 is a flowchart illustrating a procedure of processing performed by the event correlation detection system according to the first exemplary embodiment of the present invention,

FIG. 3 is a block diagram illustrating a configuration of an event correlation detection system according to a second exemplary embodiment of the present invention,

FIG. 4A is a flowchart illustrating a procedure of processing performed by the event correlation detection system according to the second exemplary embodiment of the present invention,

FIG. 4B is a flowchart illustrating a procedure of processing performed by the event correlation detection system according to the second exemplary embodiment of the present invention,

FIG. 5 is a block diagram illustrating a configuration of a rule generation unit in the second exemplary embodiment of the present invention,

FIG. 6 is a block diagram illustrating a configuration of a rule candidate storage unit in the second exemplary embodiment of the present invention,

FIG. 7 is a block diagram illustrating a configuration of a threshold calculation unit in the second exemplary embodiment of the present invention,

FIG. 8 is a block diagram illustrating a configuration of a threshold storage unit in the second exemplary embodiment of the present invention,

FIG. 9 is a flowchart regarding an event correlation detection procedure in the second exemplary embodiment of the present invention,

FIG. 10 is a block diagram illustrating a configuration of a minimum reliability rate calculation unit in the second exemplary embodiment of the present invention,

FIG. 11 is a flowchart regarding processing performed by the minimum reliability rate calculation unit in the second exemplary embodiment of the present invention,

FIG. 12 is a block diagram illustrating a configuration of a minimum supporting rate calculation unit in the second exemplary embodiment of the present invention,

FIG. 13 is a flowchart regarding processing performed by the minimum supporting rate calculation unit in the second exemplary embodiment of the present invention,

FIG. 14 is a diagram illustrating characteristics of values stored in a probability distribution storage unit 620 in the second exemplary embodiment of the present invention,

FIG. 15 is a diagram illustrating characteristics of values stored in a probability distribution storage unit 720 in the second exemplary embodiment of the present invention,

FIG. 16 is a diagram illustrating an exemplary reference table indicating association between an event type and occurrence probability that are stored in an occurrence probability table storage unit in the second exemplary embodiment of the present invention,

FIG. 17 is a diagram illustrating an exemplary reference table indicating association between a minimum supporting rate and a supporting rate in the second exemplary embodiment of the present invention,

FIG. 18 is a diagram illustrating an exemplary reference table indicating association between a minimum reliability rate and a reliability rate in the second exemplary embodiment of the present invention,

FIG. 19 is a diagram illustrating an exemplary reference table indicating association between an event type and an arrival rate that are stored in an event arrival rate table storage unit in the second exemplary embodiment of the present invention,

FIG. 20 is a block diagram schematically illustrating a hardware configuration of a computer processing apparatus that can implement the event correlation detection system according to the exemplary embodiments,

FIG. 21 is a block diagram illustrating a typical event correlation detection system,

FIG. 22 is a diagram illustrating an example of rule generation technique in the event correlation detection system,

FIG. 23 is a diagram schematically illustrating a state where occurrence of an event is classified in an event type window,

FIG. 24 is a diagram illustrating a specific example of an event window table,

FIG. 25 is a diagram illustrating an example of an image associated with an event type window table, and

FIG. 26 is a diagram schematically illustrating information stored in an event history DB.

### DESCRIPTION OF EMBODIMENTS

The exemplary embodiments of the present invention will be described in detail below with reference to the drawings.

### First Exemplary Embodiment

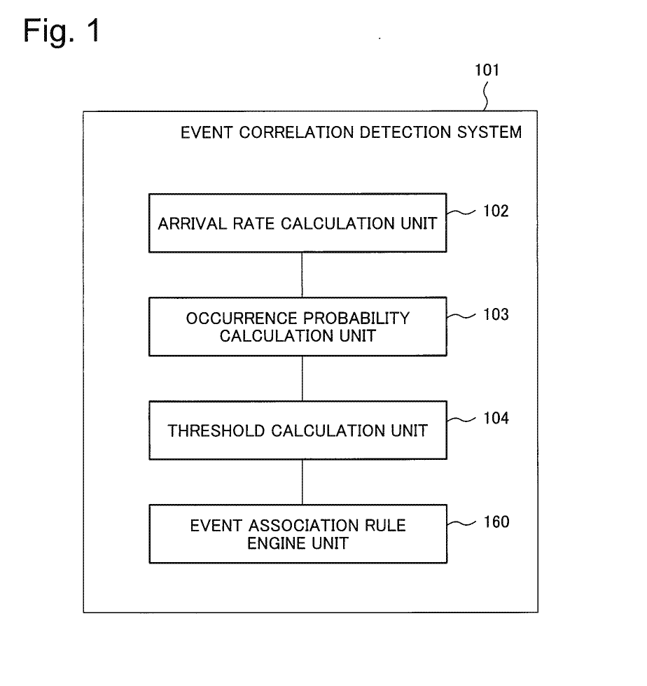

FIG. 1 is a block diagram illustrating a configuration of an event correlation detection system 101 according to a first exemplary embodiment of the present invention. Referring to FIG. 1, the event correlation detection system 101 according to the first exemplary embodiment includes an arrival rate calculation unit 102, an occurrence probability calculation unit 103, a threshold calculation unit 104, and an event association rule engine unit 160.

The arrival rate calculation unit 102 calculates the number of arrivals per unit time (hereafter referred to as an “arrival rate”) for each event. The occurrence probability calculation unit 103 calculates a probability P(E|W) of occurrence of an event E having a certain event type during a fixed time period of W second (sec) in accordance with the arrival rate calculated by the arrival rate calculation unit 102, and calculates a supporting rate SR and a reliability rate TR, which are described in the background art section of this specification. In the following, the fixed time period W will also be referred to as a “predetermined time period.”

The threshold calculation unit 104 calculates a probability of occurrence of every event included in a rule candidate, based on the probability P(E|W). The threshold calculation unit 104 also calculates two kinds of probability distributions, based on the probability calculated as described above and the supporting rate SR described above, or the probability calculated and the reliability rate TR described above. The threshold calculation unit 104 then calculates respective thresholds with which an area of a region corresponding to an erroneous detection rate in the above two kinds of probability distributions is equal to or less than an assumed erroneous detection rate, and sets the calculated thresholds respectively as the minimum supporting rate or the minimum reliability rate.

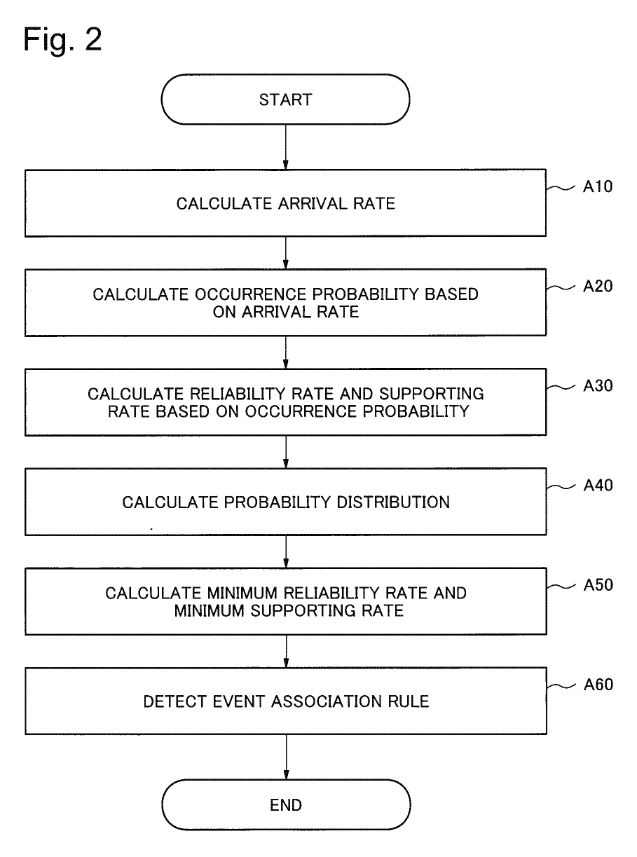

The following describes an operation for creating an event association rule by the event correlation detection system 101 according to the exemplary embodiment with reference to the flowchart of FIG. 2. FIG. 2 is a flowchart illustrating a procedure of processing performed by the event correlation detection system 101 according to the first exemplary embodiment of the present invention.

The arrival rate calculation unit 102 calculates an arrival rate of each event, based on a history of occurrence of the event (step A10). The occurrence probability calculation unit 103 calculates, based on the arrival rate of each event calculated by the arrival rate calculation unit 102, a probability of occurrence of the event (step A20), and the supporting rate SR and the reliability rate TR as described in the background art section (step A30).

The threshold calculation unit 104 calculates two kinds of probability distributions, based on the probability calculated as described above and the supporting rate SR described above, or based on the calculated probability and the reliability rate TR described above (step A40). The threshold calculation unit 104 calculates respective thresholds with which an area of a region corresponding to an erroneous detection rate in the above-described two types of probability distributions is equal to or less than the assumed erroneous detection rate, and sets the calculated thresholds respectively as the minimum supporting rate or the minimum reliability rate (step A50).

The event association rule engine unit 160 detects an association among the above event types, in accordance with a value of the minimum supporting rate calculated by the threshold calculation unit 104, or the minimum reliability rate (step A60). The event correlation detection system 101 according to the first exemplary embodiment of the present invention calculates, as described above, thresholds each of which is equal to or less than the assumed erroneous detection rate, and sets the calculated threshold values respectively as the minimum supporting rate or the minimum reliability rate.

Accordingly, the first exemplary embodiment of the present invention makes it possible to reduce the erroneous detection rate to an allowable level.

### Second Exemplary Embodiment

The following describes a second exemplary embodiment, which is based on the first exemplary embodiment described above.

The following description mainly focuses on specific features according to this exemplary embodiment, and the same configuration as that in the first exemplary embodiment described above is denoted by the same reference numerals, redundant explanation of which is omitted.

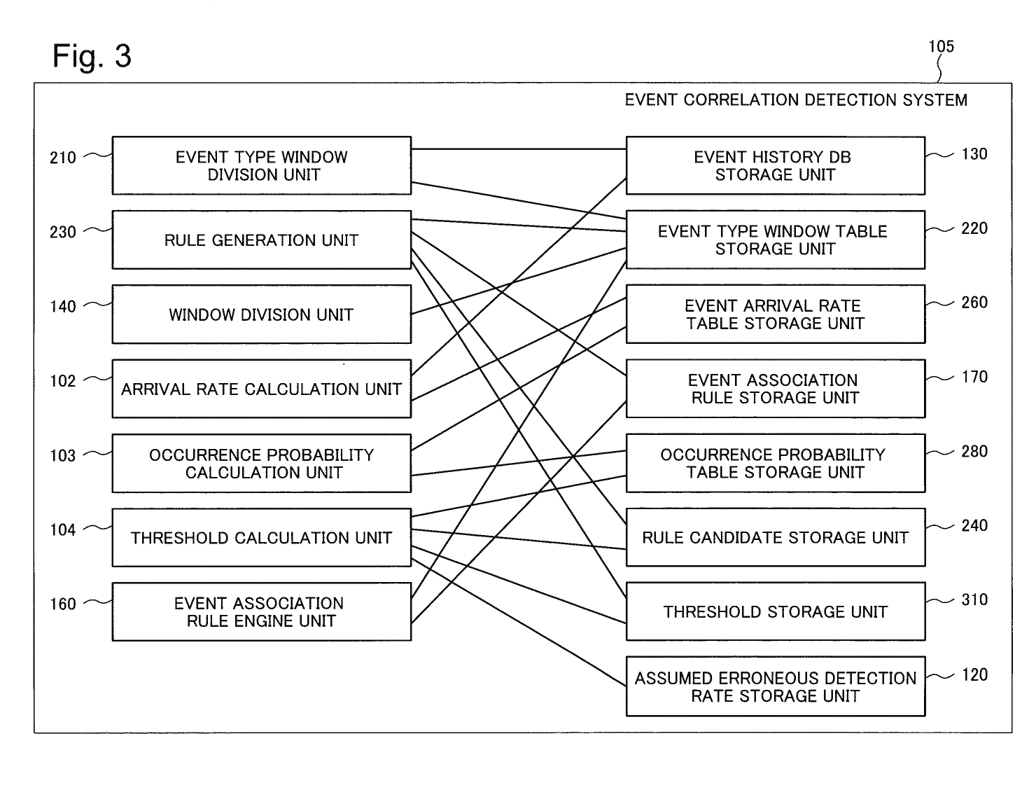

FIG. 3 is a block diagram illustrating a configuration of an event correlation detection system 105 according to the second exemplary embodiment of the present invention.

Referring to FIG. 3, the event correlation detection system 105 includes a window division unit 140 classifying an event in each fixed time period W (sec), and an event type window table storage unit 220 storing information associated with an event type window. The event correlation detection system 105 further includes an event association rule engine unit 160 detecting an event that has an association based on a value stored in an event association rule storage unit 170.

The event correlation detection system 105 further includes an arrival rate calculation unit 102 and an occurrence probability calculation unit 103. The arrival rate calculation unit 102 calculates an arrival rate for each event, based on a value of an event history DB storage unit 130. The occurrence probability calculation unit 103 calculates a probability of occurrence of an event having a certain event type during a fixed time period W (sec), based on the event arrival rate.

The event correlation detection system 105 still further includes an event type window division unit 210 and a rule generation unit 230. The event type window division unit 210 discriminates an event type in each fixed time period W (sec) based on an occurrence time of the event in the event history DB storage unit 130. The rule generation unit 230 generates an event association rule.

Specifically, the rule generation unit 230 generates a set of events having a high rate of concurrence as a rule candidate by referring to the event type window stored in the event type window table storage unit 220. The rule generation unit 230 then stores the result in a rule candidate storage unit 240. The rule generation unit 230 then generates an event association rule using a value stored in the rule candidate storage unit 240 and a threshold stored in a threshold storage unit 310.

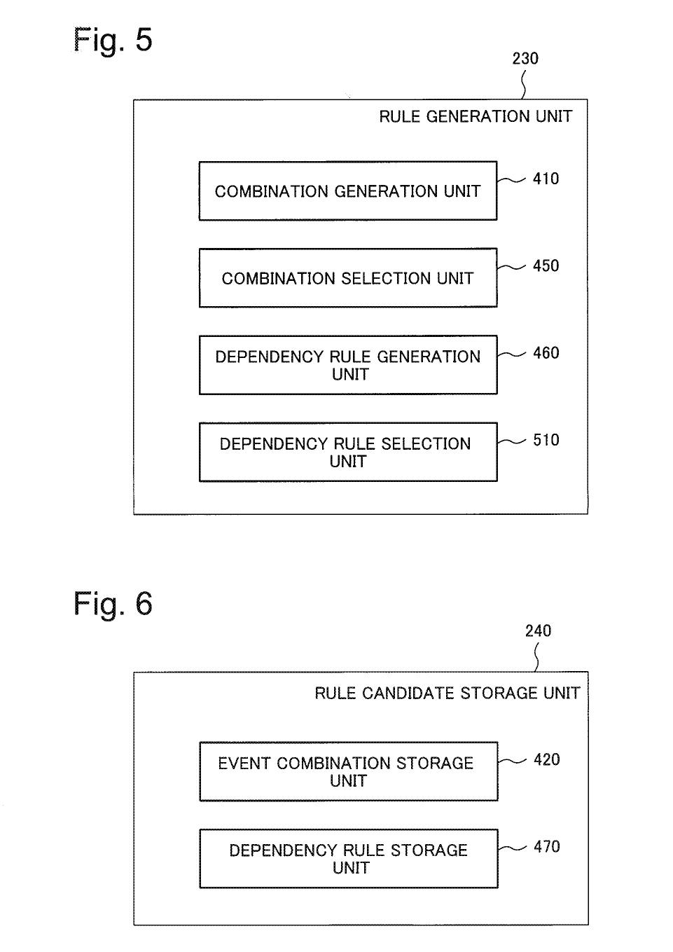

FIG. 5 is a block diagram illustrating a configuration of the rule generation unit 230 in the second exemplary embodiment of the present invention. As illustrated in FIG. 5, the rule generation unit 230 includes a combination generation unit 410, a combination selection unit 450, a dependency rule generation unit 460, and a dependency rule selection unit 510.

FIG. 6 is a block diagram illustrating a configuration of the rule candidate storage unit 240 in the second exemplary embodiment of the present invention. As illustrated in FIG. 6, the rule candidate storage unit 240 includes an event combination storage unit 420 and a dependency rule storage unit 470.

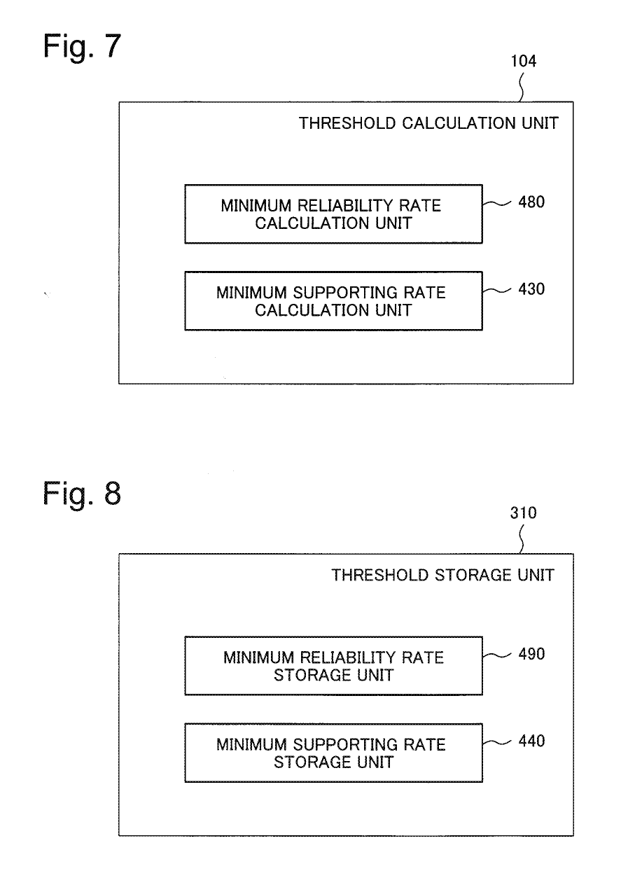

FIG. 7 is a block diagram illustrating a configuration of a threshold calculation unit 104 in the second exemplary embodiment of the present invention. As illustrated in FIG. 7, the threshold calculation unit 104 includes a minimum supporting rate calculation unit 430 and a minimum reliability rate calculation unit 480.

FIG. 8 is a block diagram illustrating a configuration of the threshold storage unit 310 in the second exemplary embodiment of the present invention. As illustrated in FIG. 8, the threshold storage unit 310 includes a minimum supporting rate storage unit 440 and a minimum reliability rate storage unit 490.

FIG. 10 is a block diagram illustrating a configuration of the minimum reliability rate calculation unit 480 in the second exemplary embodiment of the present invention. Referring to FIG. 10, the minimum reliability rate calculation unit 480 includes a probability distribution calculation unit 710, a probability distribution storage unit 720, and a distribution probability inverse calculation unit 730. FIG. 12 is a block diagram illustrating a configuration of the minimum supporting rate calculation unit 430 in the second exemplary embodiment of the present invention. Referring to FIG. 12, the minimum supporting rate calculation unit 430 includes a probability distribution calculation unit 610, a probability distribution storage unit 620, and a distribution probability inverse calculation unit 630. Operations of these units will be described later as well as description of flowcharts.

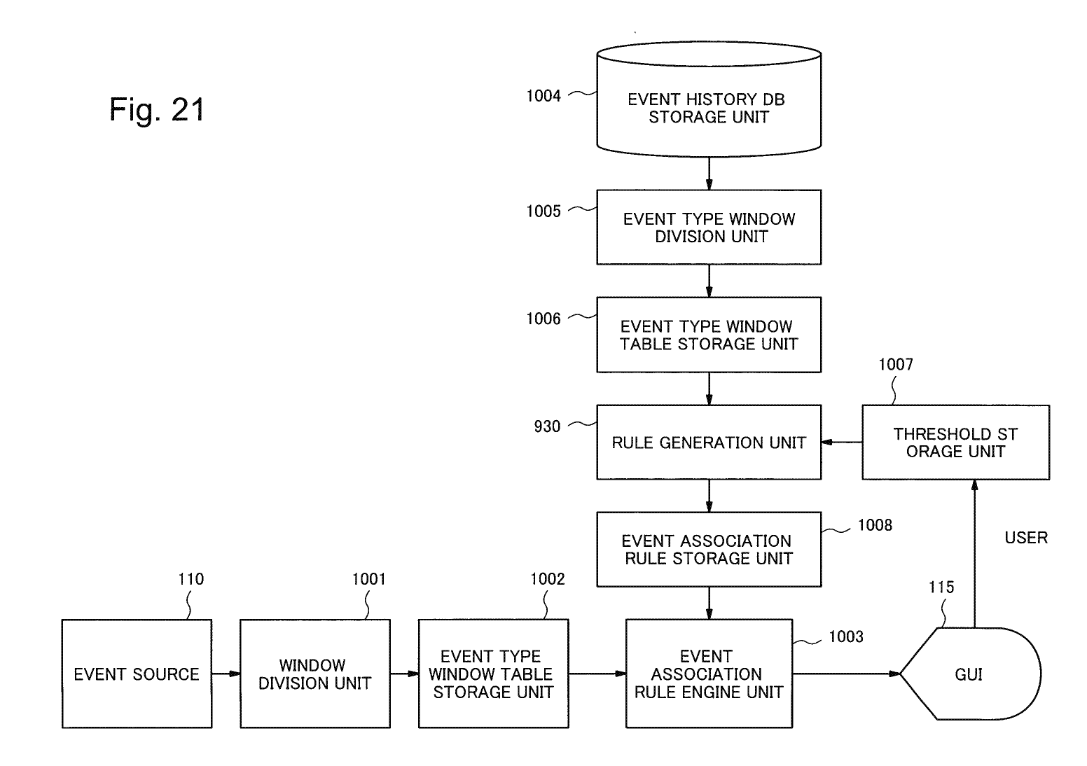

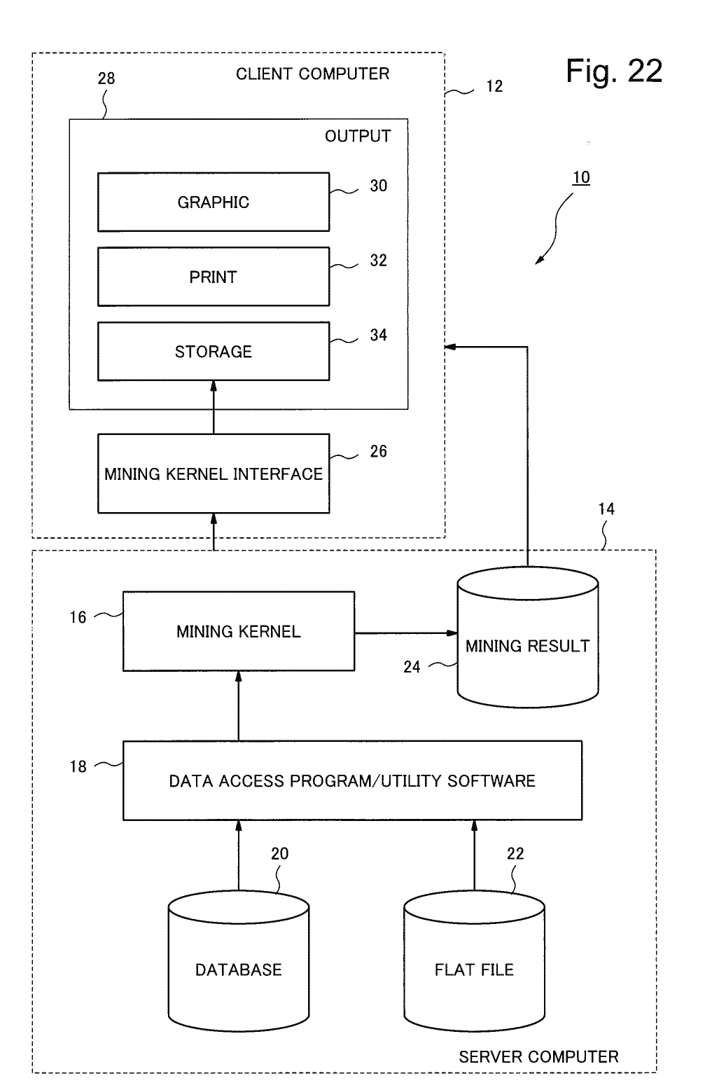

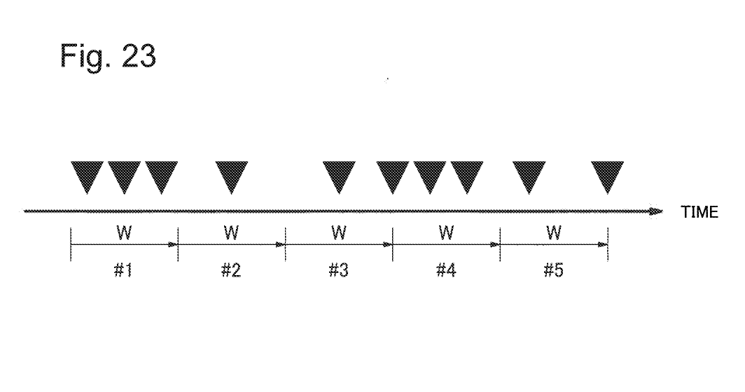

An event source (the event source 110 in FIG. 21) causes an event to occur. It is assumed in the description according to this exemplary embodiment that events occur in accordance with the Poisson distribution.

A data center may be described as an example of the event source. The data center includes many servers, network devices, storage devices, and the like. Those servers in the data center typically cause an event to occur independently of each other. As in the case of the servers in the data center, when many devices independently cause an event to occur, the entire events can be assumed to occur in accordance with the Poisson distribution. When the event source is the data center, a user of this system may be an operator of the data center.

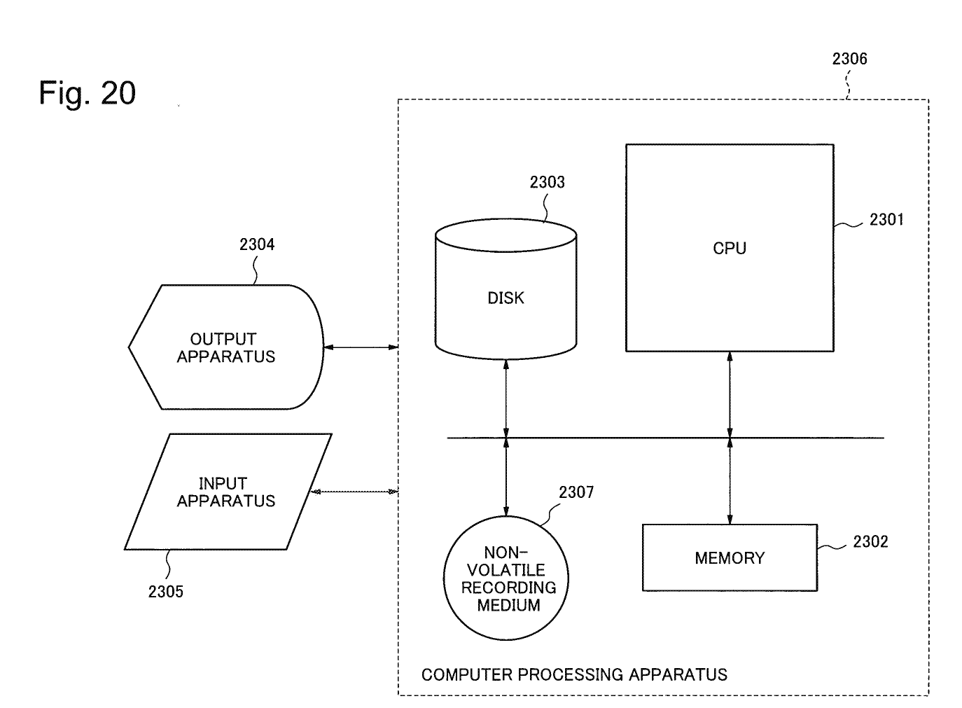

The graphical user interface (GUI) (for example, an input apparatus 2305 in a hardware configuration (FIG. 20), which will be described later) is an interface that allows a user to input an assumed erroneous detection rate acceptable to the user. Further, the GUI (for example, an output apparatus 2304 in the hardware configuration (FIG. 20), which will be described later) presents, to a user, an event having an association that is detected by the event association rule engine unit 160.

An assumed erroneous detection rate storage unit 120 stores a value indicating an erroneous detection rate that is acceptable to a user. The erroneous detection rate is a probability of existence of a rule that does not have an association among the event association rules stored in the event association rule storage unit 170.

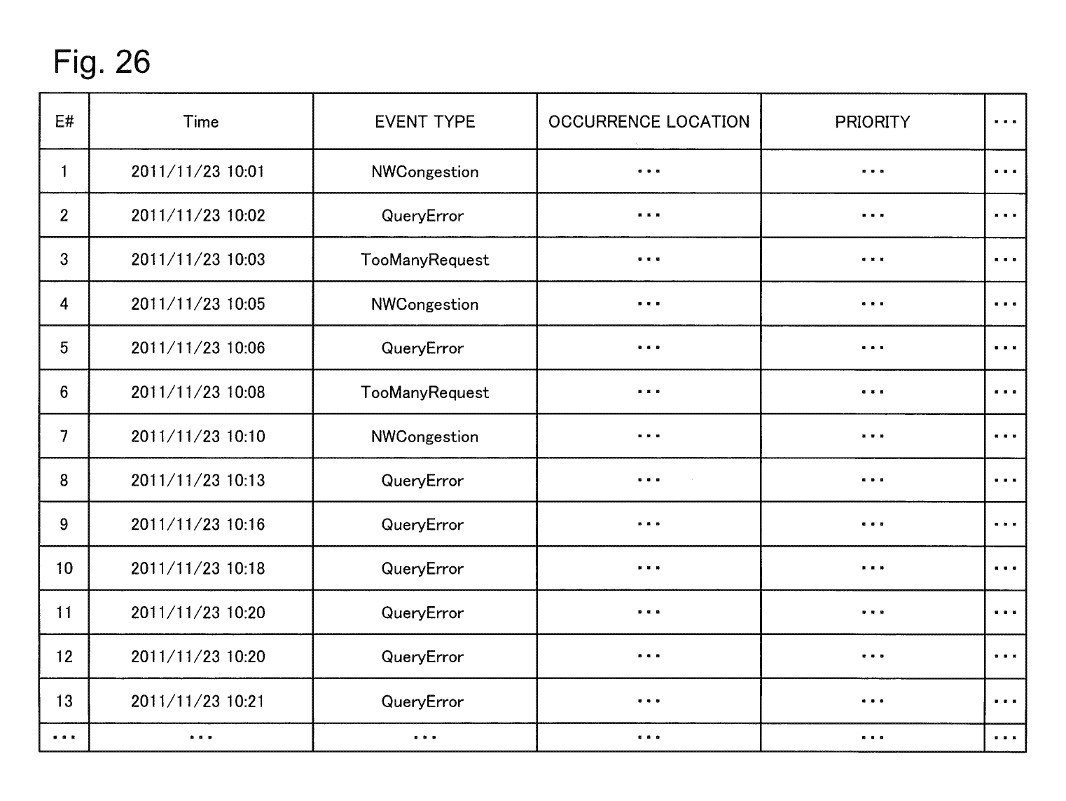

The following describes the event correlation detection system 105 according to the exemplary embodiment with reference to FIGS. 3, 21, and 26. FIG. 26 is a diagram schematically illustrating an example of information that can be stored in the event history DB storage unit. The information that can be stored in the event history DB storage unit in FIG. 26 is also used by the event correlation detection system 105 according to the second exemplary embodiment of the present invention. FIG. 3 is a block diagram illustrating the configuration of the event correlation detection system 105 according to the second exemplary embodiment of the present invention. The event history DB storage unit 130 stores a history associated with an event that is previously caused by the event source (the event source 110 in FIG. 21). The event history DB storage unit 130 stores an event occurrence time, an event type, and the like associated with each other. The event history DB storage unit 130 may store the event history in association with a value other than the above-described exemplary parameters.

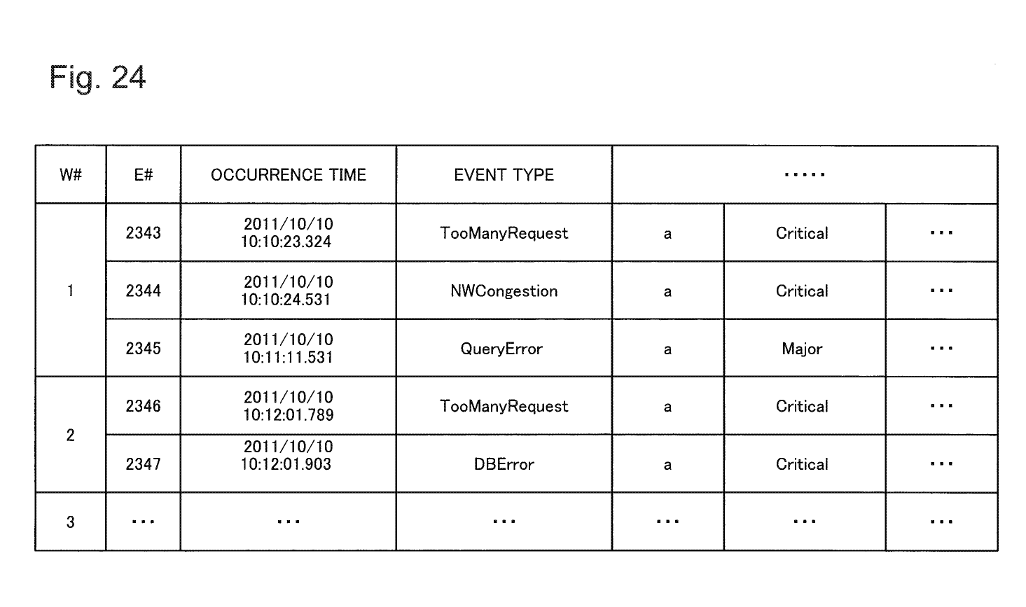

The window division unit 140 classifies an event caused by the event source (the event source 110 in FIG. 21) into the event type window. The window division unit 140 then stores information regarding the classified event type window in the event type window table storage unit 220. FIG. 24 is a diagram illustrating a specific example of the event window table. The event window table is a table to be stored not only by the associated event correlation detection system but also by the event correlation detection system in the second exemplary embodiment of the present invention.

The event association rule engine unit 160 selects an event having an association in terms of occurrence among the events stored in the event type window table storage unit 220, in accordance with the value stored in the event association rule storage unit 170. For example, it is assumed that there exists an event association rule “A, B [symbol] C” which indicates that an event having an event type C occurs in response to occurrence of an event having an event type A and an event having an event type B. In addition, it is assumed that an event E3 having the event type C occurs in a certain event type window W1.

An event E1 having the event type A and an event E2 having the event type B are assumed to occur immediately before occurrence of the event E3 in the event type window W 1. In this case, the event association rule engine unit 160 decides that there is an association among occurrence of the events E1, E2, and E3 in accordance with the above event generation rule.

The event association rule storage unit 170 stores an antecedent including events having at least one event type and a consequent including an event having a certain event type, associated with each other. For example, when A, B, and C each represents an event type, an event association rule “A, B [symbol] C” represents an association that “an event having an event type C occurs in response to occurrence of an event having an event type A and an event having an event type B.” When the event association rule is “A, B [symbol] C,” the “antecedent” corresponds to “A, B” residing in the left of “ [symbol] ”, and the “consequent” corresponds to “C” residing in the right of “ [symbol] .”

The event type window division unit 210 classifies the events stored in the event history DB storage unit 130 in a unit of event type window. The event type window division unit 210 then associates an event type regarding an event occurring in the event type window with an identifier indicating the event type window (hereafter abbreviated as an “ID”), and stores the result in the event type window table storage unit 220.

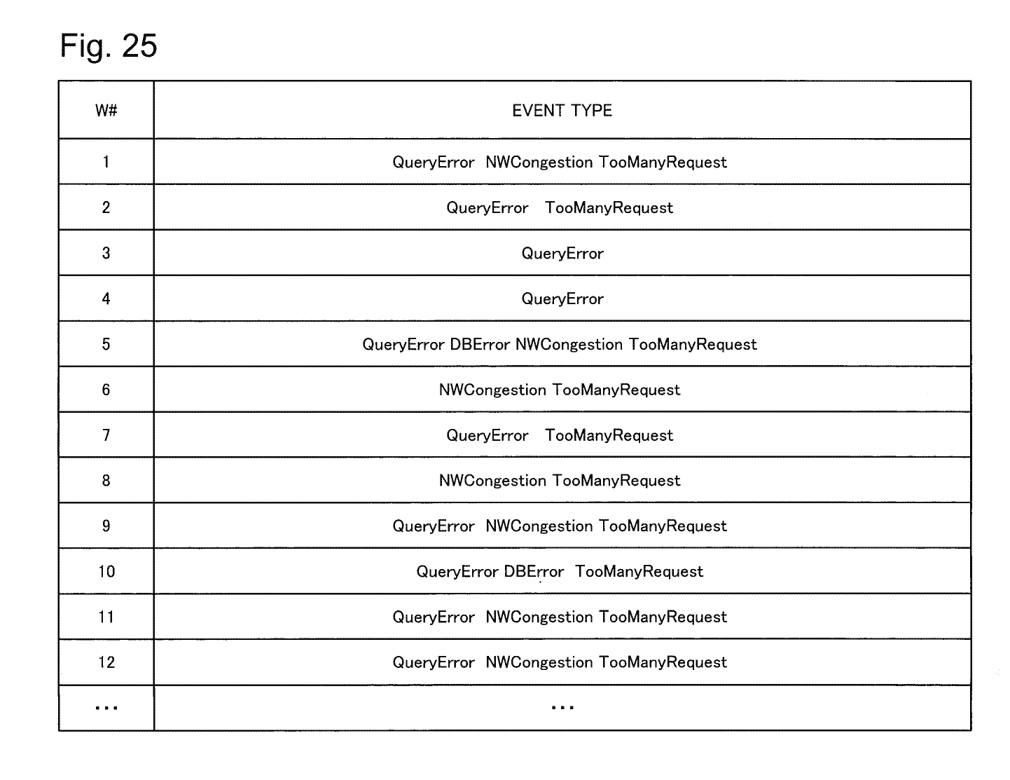

The event type window table storage unit 220 stores the event type for each event type window. FIG. 25 is a diagram illustrating an example of an image associated with the event type window table. For example, the event type window table may associate an ID (W#) regarding the event type window with a set of event types of the events residing in the event type window and the like. The event type window table is information held not only by the associated event correlation detection system but also by the event correlation detection system in the second exemplary embodiment of the present invention.

The rule generation unit 230 refers to a threshold and thus generates an event association rule, and stores the result in the event association rule storage unit 170. The following describes an example of the configuration of the rule generation unit 230 and the like.

As illustrated in FIG. 5, the rule generation unit 230 includes the combination generation unit 410, the combination selection unit 450, the dependency rule generation unit 460, and the dependency rule selection unit 510.

It is assumed that there are event types A, B, C, D, and E in the event type window. In addition, it is assumed that the combination selection unit 450 chooses {A, B} among the combinations of the event types stored in the event combination storage unit 420. The combination generation unit 410 generates a new event type combination by adding one event type in the event type window to the event type combination {A, B} selected by the combination selection unit 450. In this exemplary case, the combination generation unit 410 generates event type combinations {A, B, C}, {A, B, D}, and {A, B, E}, and outputs the combinations to the event combination storage unit 420.

The combination selection unit 450 selects an event combination in which the calculated supporting rate SR is relevant to a value equal to or larger than the minimum supporting rate stored in the minimum supporting rate storage unit 440, among the event combinations stored in the event combination storage unit 420.

The combination selection unit 450 calculates a supporting rate s(A, B, . . . ) for an event type combination A, B, . . . in accordance with Eqn. 1:

s(A,B, . . . )=(the number of event type windows including the combination A,B, . . . )÷(the total number of event type windows) (Eqn. 1).

The dependency rule generation unit 460 generates a dependency rule in accordance with the following processing for at least one event combination selected by the combination selection unit 450. For example, it is assumed that the combination selection unit 450 selects an event type combination {A, B, C}. In this case, the dependency rule generation unit 460 generates dependency rules of “A, B [symbol] C”, “B, C [symbol] A,” and “C, A [symbol] B” based on the event type combination, and stores the dependency rules in the dependency rule storage unit 470.

The dependency rule selection unit 510 selects a dependency rule in which the reliability rate TR is equal to or larger than the minimum reliability rate among the dependency rules generated by the dependency rule generation unit 460. The dependency rule selection unit 510 identifies the selected dependency rule as an event association rule, and stores the result in the event association rule storage unit 170. The combination selection unit 450 calculates a reliability rate t(B, C [symbol] A) regarding the dependency rule “B, C [symbol] A” in accordance with Eqn. 2:

t(B,C [symbol] A)=(the number of event type windows including A,B, and C)÷(the number of event type windows including B and C) (Eqn. 2).

As illustrated in FIG. 6, the rule candidate storage unit 240 includes an event combination storage unit 420 and a dependency rule storage unit 470. The rule candidate storage unit 240 stores work data generated temporarily by the rule generation unit 230.

The event combination storage unit 420 stores the event type combination obtained as a result of combining a plurality of event types. For example, in the above case, an example of values stored in the event combination storage unit 420 is assumed to include, for example, {A, B, C}, {A, B, D}, {A, B, E} as such event type combinations.

The dependency rule storage unit 470 stores a rule that combines an “antecedent” including a plurality of event types with a “consequent” including an event type. The rule stored in the dependency rule storage unit 470 represents an association among the event types. For example, it is assumed that A, B, and C each represents an event type. In this case, an event association rule “A, B [symbol] C” represents an association that “an event having an event type C occurs in response to occurrence of an event having an event type A and an event having an event type B.”

The arrival rate calculation unit 102 calculates an event occurrence frequency (which is assumed to be “λE” (/sec) as described above) for each event type (it is assumed that the event type is E), based on the event history DB stored in the event history DB storage unit 130. For example, when the event E occurs NE times during a time period T, the arrival rate calculation unit 102 calculates an event occurrence frequency λE in accordance with processing as represented by Eqn. 3:

λE=NE÷T (Eqn. 3).

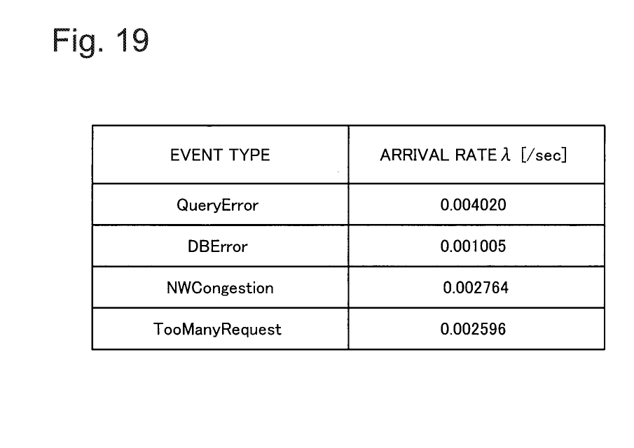

FIG. 19 is a diagram illustrating an exemplary reference table indicating association between the event type and the arrival rate that are stored in the event arrival rate table storage unit 260 in the second exemplary embodiment of the present invention. The event arrival rate table storage unit 260 stores the event type and the arrival rate at which the event type arrives, associated with each other.

The occurrence probability calculation unit 103 calculates an occurrence probability for each event type of an event which occurs once or more times during a fixed time period W, in accordance with the following processing. It is assumed that an event having the event type E occurs in accordance with the Poisson distribution. In this case, the occurrence probability calculation unit 103 calculates the occurrence probability Pr(|E|>0|W) of one or more times of occurrence of the event having the event type E during a fixed time period W, in accordance with processing represented by Eqn. 4:

Pr(|E|>0|W)=1−exp(−λE×W) (Eqn. 4)

(where |E| represents the number of times of occurrence of the event having the event type E, λE is the event occurrence frequency described above, and exp( ) is an exponential function with a base of natural logarithm.)

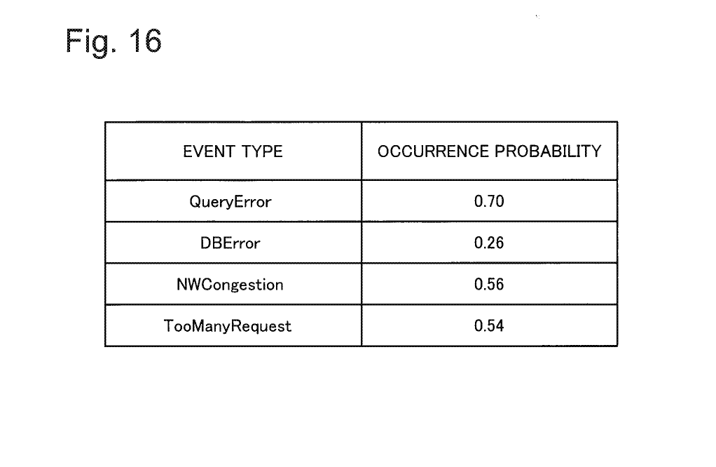

The occurrence probability table storage unit 280 stores the value calculated by the occurrence probability calculation unit 103 as represented by Eqn. 4 and the event type, associated with each other. FIG. 16 is a diagram illustrating an exemplary reference table indicating association between the event type and the occurrence probability that are stored in the occurrence probability table storage unit in the second exemplary embodiment of the present invention.

The occurrence probability table storage unit 280 stores the event type and the occurrence probability Pr(|E|>0|W) calculated in accordance with such an equation as Eqn. 4, associated with each other.

As illustrated in FIG. 7, the threshold calculation unit 104 includes the minimum supporting rate calculation unit 430 and the minimum reliability rate calculation unit 480. The threshold calculation unit 104 calculates a threshold in accordance with the following processing and stores the threshold in the threshold storage unit 310. As such, when the threshold calculation unit 104 performs processing based on the threshold stored in the threshold storage unit 310, the erroneous detection rate becomes equal to or less than the assumed erroneous detection rate stored in the assumed erroneous detection rate storage unit 120. The threshold calculation unit 104 calculates the minimum supporting rate and stores the calculated value in the minimum supporting rate storage unit 440. The threshold calculation unit 104 also calculates the minimum reliability rate and stores the calculated value in the minimum reliability rate storage unit 490. The threshold calculation unit 104 calculates the threshold in accordance with the following flow.

As illustrated in FIG. 12, the minimum supporting rate calculation unit 430 includes the probability distribution calculation unit 610, the probability distribution storage unit 620, and the distribution probability inverse calculation unit 630. The minimum supporting rate calculation unit 430 calculates an erroneous detection rate in accordance with the following processing. As a result, the calculated erroneous detection rate becomes a value equal to or less than the assumed erroneous detection rate stored in the assumed erroneous detection rate storage unit 120.

A processing method of the minimum supporting rate calculation unit 430 is described as follows. The probability distribution calculation unit 610 refers to the event combination storage unit 420 and retrieves a specific event type combination C among the event combinations. The event type combination C includes a plurality of event types. The probability distribution calculation unit 610 then refers to the occurrence probability table storage unit 280 and retrieves an occurrence probability associated with the event type. The probability distribution calculation unit 610 performs the above processing for the entire event types included in the event type combination C.

The probability distribution calculation unit 610 then calculates the probability Pr(C|W) of occurrence of the event type combination C assuming that the event types included in the event type combination C occur independently of each other, in accordance with processing represented by Eqn. 5:

Pr(C|W)=ΠEεC_{—}Pr(|E|>0|W) (Eqn. 5)

(where ΠEεC_Pr(|E|>0|W) represents multiplication of any event type E pertaining to the event type combination C by Pr(|E|>0|W).)

The probability distribution calculation unit 610 then calculates the probability G(i) of occurrence of the event type combination C in i windows out of the Nw windows, in accordance with processing represented by Eqn. 6:

G(i)=C(Nw,i)P(C|W)↑i×(1−P(C|W))↑(Nw−i) (Eqn. 6)

(where C(Nw, i) represents the number of combinations when i combinations are taken out of Nw combinations, Nw is the total number of the windows in the event type window table, and W↑i represents exponentiation. Specifically, W↑i represents 1 multiplied by W i times, where i is a natural number.)

G(i) is equal to the binomial distribution B(Nw, Pr(C|W)). The probability distribution calculation unit 610 associates the number i of the occurrence windows with the calculated G(i), and stores the result in the probability distribution storage unit 620. The probability distribution storage unit 620 stores the number i of windows described above and the value of G(i) associated with each other.

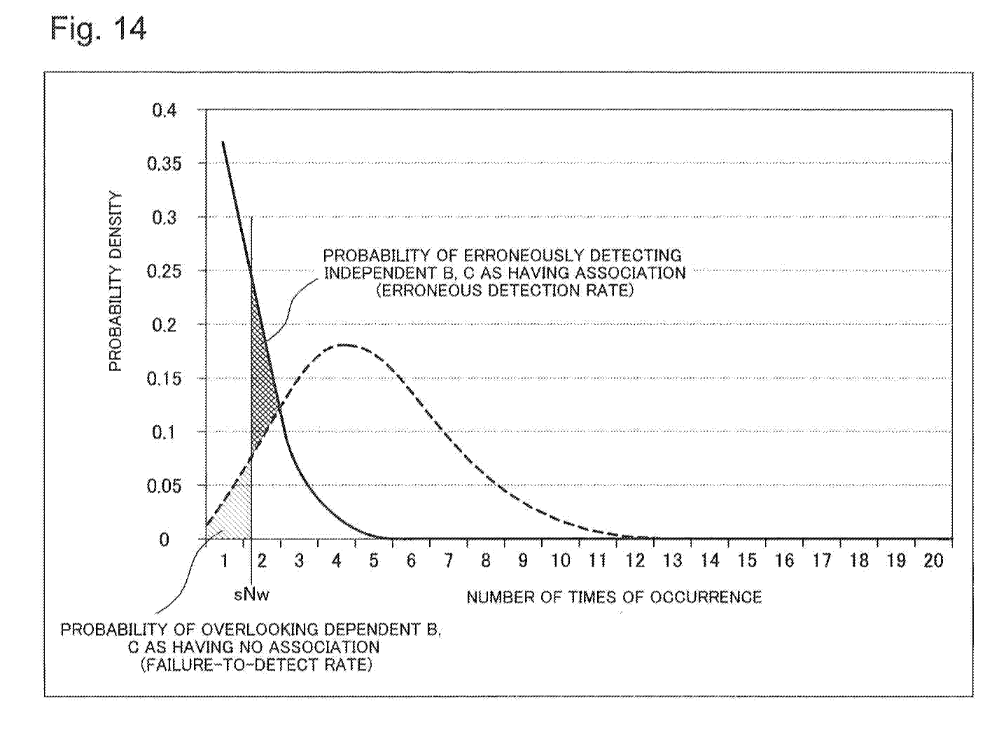

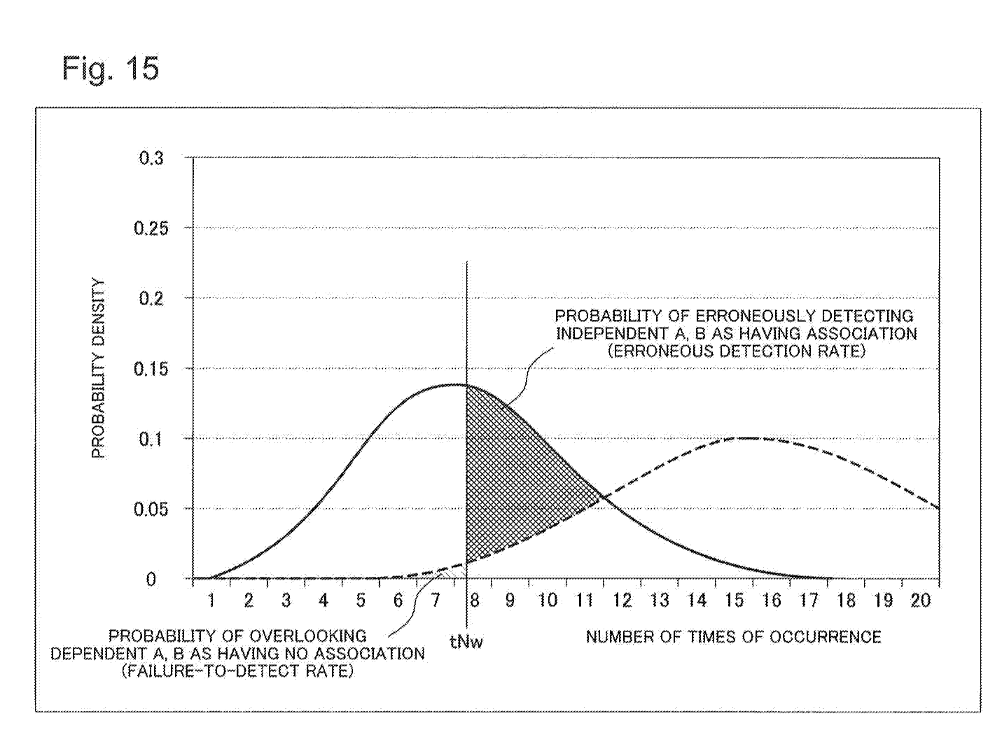

FIG. 14 is a diagram illustrating characteristics of information stored in the probability distribution storage unit 620 in the second exemplary embodiment of the present invention. The horizontal axis of FIG. 14 indicates the number of windows in which the event type combination C occurs (the number of times of occurrence). The vertical axis of FIG. 14 indicates a probability (probability density) that is associated with the number i of occurrence windows described above in a probability distribution stored in the probability distribution storage unit 620. The solid curve in FIG. 14 indicates a probability of occurrence of a combination of the event types that occur, assuming that each event having the event type occurs independently. The dotted curve in FIG. 14 indicates a probability of occurrence when occurrence of each event in the event type combination is not independent.

The following describes a calculation method for calculating a minimum supporting rate s in the minimum supporting rate calculation unit 430 with reference to FIG. 14. For example, it is assumed that an event type combination C includes an event type C1 and an event type C2.

As discussed above, the probability distribution calculation unit 610 calculates the probability G(i) of occurrence of the event type combination, assuming that an event having the event type C1 and an event having the event type C2 occur independently of each other. The solid line in FIG. 14 indicates the probability G(i). Specifically, the solid line in FIG. 14 indicates the binomial distribution B(Nw, Pr(C|W)) as described above.

When the minimum supporting rate is indicated by s in FIG. 14, and in a case that the occurrence frequency is larger than (s×Nw) indicated on the vertical axis, the apparatus according to this exemplary embodiment decides that occurrence of the respective events in the event type combination has dependency upon each other. However, events B and C in the event type combination are actually independent of each other. As a result, a portion indicated by the lattice pattern in FIG. 14 implies detection of erroneous results.

When the assumed erroneous detection rate stored in the assumed erroneous detection rate storage unit 120 is represented by p0, the distribution probability inverse calculation unit 630 calculates the lowest s that satisfies Eqn. 7:

(Σi>s_{—}Nw×G(i))<p0 (Eqn. 7)

(where (Σi>s_Nw×G(i)) represents obtaining a sum of Nw×G(i) for i taking a value larger than s, and i is a natural number.)

With regard to a method for calculating s, values may be sequentially substituted for i from a large number to find a value that no more satisfies Eqn. 7, or analytical calculation may be employed using a method such as Newton's method. The method for calculating the lowest s is not limited to the above exemplary methods.

The dotted line in FIG. 14 indicates a probability distribution in a case that occurrence of the events B and C in the event type combination is not independent. A region defined by the dotted line in FIG. 14 and the right side of a vertical line corresponding to occurrence frequency of (s×Nw) on the horizontal axis is a portion where the apparatus according to this exemplary embodiment correctly detects that occurrence of the events B and C in the event type combination is not independent. Meanwhile, the size of a region defined by the dotted line in FIG. 14 and the left side of a vertical line corresponding to occurrence frequency of (s×Nw) on the horizontal axis (the shaded portion in FIG. 14) is equal to or lower than the minimum supporting rate. Therefore, the apparatus according to this exemplary embodiment does not select this portion.

Accordingly, the event correlation detection system according to this exemplary embodiment is not capable of performing the detection, although occurrence of the events B and C in the event type combination is not independent. Therefore, the minimum supporting rate calculation unit 430 calculates the minimum supporting rate by calculating s that satisfies Eqn. 7. As a result, this exemplary embodiment of the present invention makes it possible to reduce the erroneous detection rate to an allowable level.

The minimum reliability rate calculation unit 480 calculates the minimum reliability rate in accordance with the following processing and stores the calculated value in the minimum reliability rate storage unit 490. In this exemplary embodiment, when such processing is performed, the value of the erroneous detection rate becomes equal to or less than the assumed erroneous detection rate stored in the assumed erroneous detection rate storage unit 120.

Specifically, as illustrated in FIG. 10, the minimum reliability rate calculation unit 480 includes the probability distribution calculation unit 710, the probability distribution storage unit 720, and the distribution probability inverse calculation unit 730. The probability distribution calculation unit 710 refers to a value associated by the occurrence probability table storage unit 280 and a dependency rule R stored in the dependency rule storage unit 470. The probability distribution calculation unit 710 then calculates the probability Pr(R) of occurrence of the dependency rule, assuming that the events having the event type included in the dependency rule R occur independently of each other. For example, when the dependency rule R is given as a dependency rule “B, C, . . . [symbol] A,” the probability distribution calculation unit 710 calculates the probability Pr(R/W) in accordance with processing represented by the Eqn. 8:

Pr(R|W)=Pr(|A|>0|W) (Eqn. 8)

(where |A| represents the number of times of occurrence of the event having the event type A.)

In this case, the probability distribution calculation unit 710 calculates a probability distribution in accordance with a binomial distribution B(Nw, Pr(R|W)) including Nw and Pr(R|W) as parameters. In the above method of calculation, Nw indicates the number of windows that are stored in the event history DB. The probability distribution calculation unit 710 stores the calculated probability distribution in the probability distribution storage unit 720.

The distribution probability inverse calculation unit 730, after referring to the probability distribution stored in the probability distribution storage unit 720, calculates the minimum reliability rate t in accordance with the following processing. FIG. 15 is a diagram illustrating characteristics of the probability distribution storage unit 720 in the second exemplary embodiment of the present invention. The horizontal axis of FIG. 15 indicates the number of windows in which a dependency rule occurs (the number of times of occurrence). The vertical axis of FIG. 15 indicates a probability density stored in the probability distribution storage unit 720. The solid line in FIG. 15 indicates a probability of occurrence of a combination of the occurring event types, assuming that the events having the event type occur independently of each other. The dotted line of FIG. 15 indicates the probability in a case that occurrence of the events in the event type combination is not independent of each other. The following describes a processing method of the distribution probability inverse calculation unit 730 for calculating the minimum reliability rate t with reference to FIG. 15.

It is assumed that the dependency rule R stored in the dependency rule storage unit 470 is “B [symbol] A.” The solid line in FIG. 15 indicates the probability distribution in a case that an event having the event type A and an event having the event type B occur independently of each other. The probability distribution calculation unit 710 performs calculation processing in accordance with the above processing, assuming that the probability distribution is a binomial distribution B(Nw, Pr(R|W)). When the minimum reliability rate is t, the apparatus according to this exemplary embodiment selects a portion where the occurrence frequency is larger than t×Nw as an event that occurs dependently on each other.

However, the solid line in FIG. 15 indicates the value calculated by the probability distribution calculation unit 710 assuming that an event having the event type A and an event having the event type B occur independently of each other. Therefore, the distribution probability inverse calculation unit 730 detects a region defined by the solid line in FIG. 15 and the right-side of a vertical line corresponding to occurrence frequency of (t×Nw) on the horizontal line (a portion indicated by a lattice pattern in FIG. 15) as events having dependency relationship on each other. The result of this detection is therefore erroneous.

Then, the distribution probability inverse calculation unit 730 calculates a lowest t that satisfies Eqn. 9 when the assumed erroneous detection rate storage unit 120 is p0:

(Σi>t_{—}Nw×dR(Nw,W,R)(i))<p0 (Eqn. 9)

(where dR(Nw, W, R)(i) represents a probability of occurrence of the value i when the probability distribution is dR(Nw, W, R), (Σi>t_Nw×dR(Nw, W, R)(i)) represents calculating a sum of Nw×dR(Nw, W, R)(i) for i that is larger than t, and i is a natural number.)

The distribution probability inverse calculation unit 730 calculates the minimum reliability rate t by referring to the value of the probability distribution storage unit 720 and the value of the assumed erroneous detection rate storage unit 120, in accordance with the above processing method.

With regard to a method of calculating t, values may be sequentially substituted for i from a large number to find a value that no more satisfies Eqn. 9, or analytical calculation may be employed using a method such as Newton's method. The method for calculating the lowest t is not limited to the above exemplary methods.

The threshold calculation unit 104 calculates a threshold in accordance with the following processing and stores the calculated value in the threshold storage unit 310. The rule generation unit 230 refers to the threshold stored in the threshold storage unit 310. As illustrated in FIG. 8, the threshold storage unit 310 includes the minimum supporting rate storage unit 440 and the minimum reliability rate storage unit 490.

The minimum supporting rate storage unit 440 stores a threshold referred to by the rule generation unit 230. The threshold calculated by the minimum supporting rate calculation unit 430 indicates a lower limit in the supporting rate SR for the event combination. The minimum reliability rate storage unit 490 stores a threshold referred to by the rule generation unit 230. The threshold calculated by the minimum reliability rate calculation unit 480 indicates a lower limit in the reliability rate TR for the dependency rule.

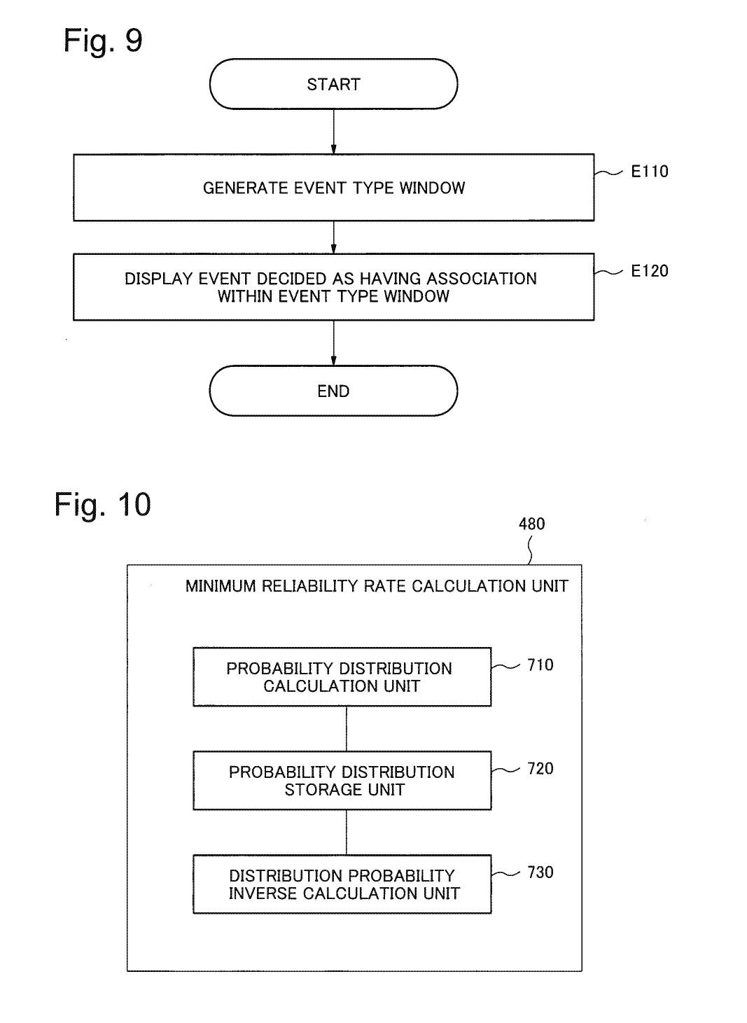

The following describes in detail an operation of the event correlation detection procedure according to this exemplary embodiment with reference to the flowchart of FIG. 9. FIG. 9 is a flowchart regarding the event correlation detection procedure in the second exemplary embodiment of the present invention.

The window division unit 140 receives an event caused by the event source (the event source 110 in FIG. 21). The window division unit 140 then classifies the received events into the event type window in each fixed time period W. The window division unit 140 then stores an ID(W#) of the event type window and a set of event types of the events that pertain to the event type window in the event type window table storage unit 220, associated with each other (step E110).

The event association rule engine unit 160 then selects events having an association among the events stored in the event type window table storage unit 220, in accordance with the value of the event association rule storage unit 170 (step E120).

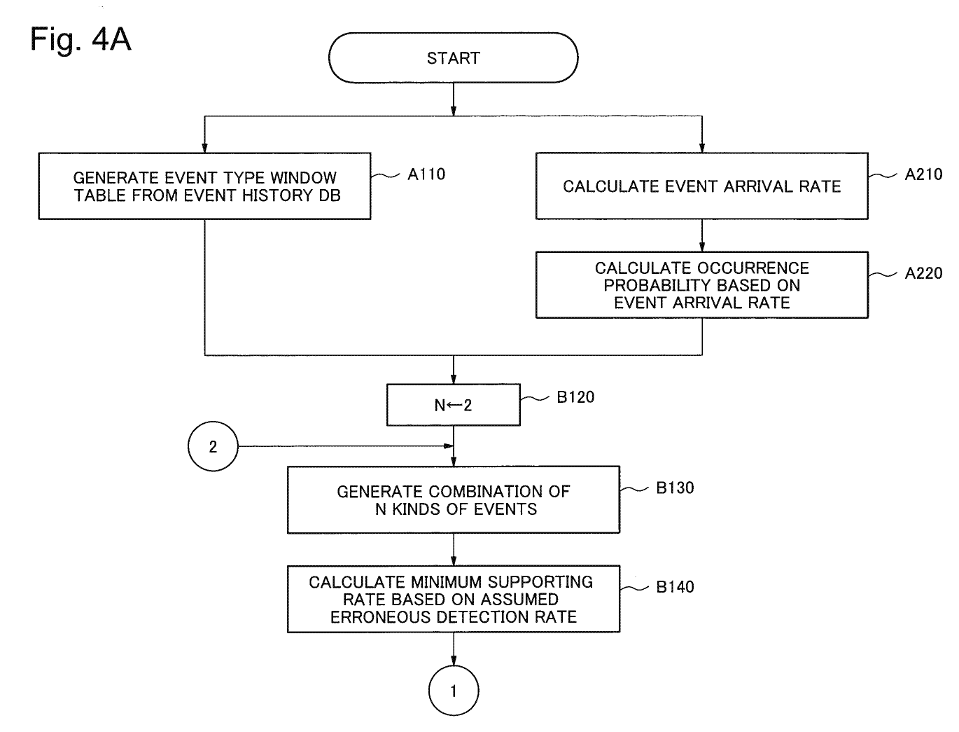

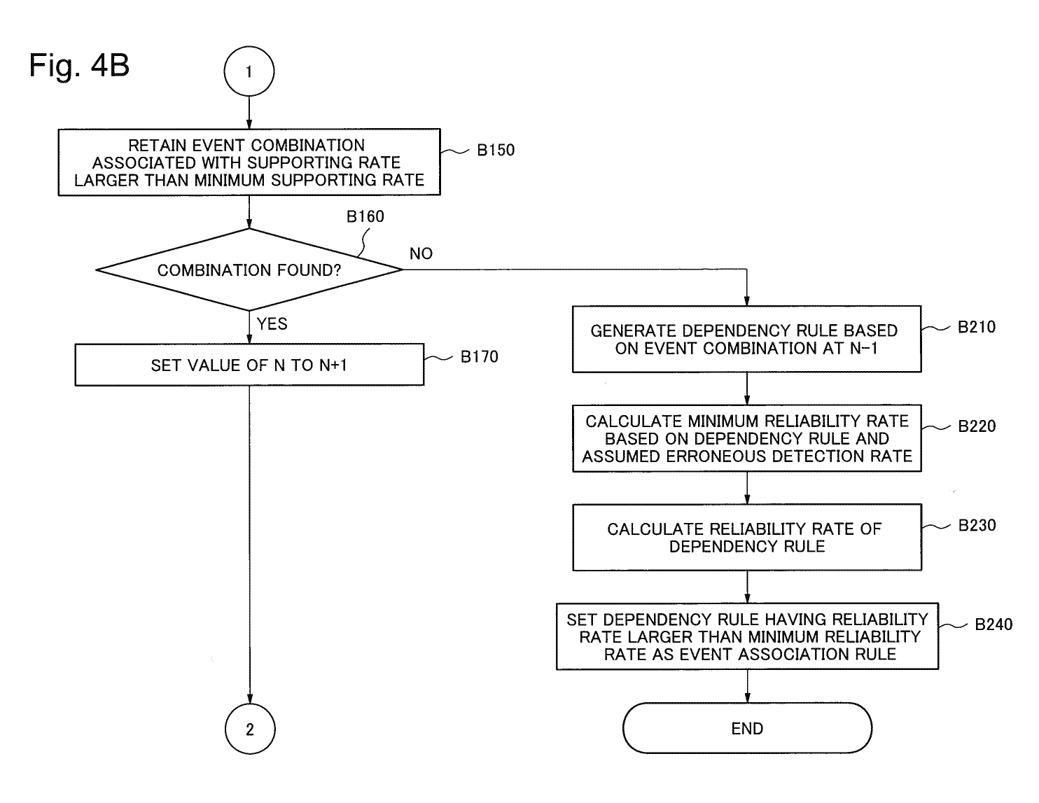

The following describes in detail an operation of the event correlation system according to the second exemplary embodiment of the present invention with reference to FIGS. 3 to 8, and 10. FIGS. 4A and 4B are a flowchart illustrating a processing procedure performed by the event correlation detection system 105 according to the second exemplary embodiment of the present invention.

The arrival rate calculation unit 102 calculates an arrival rate for each event stored in the event history DB storage unit 130, by referring to the value held by the event history DB storage unit 130, in accordance with the above processing. The arrival rate calculation unit 102 then stores the event and the calculated arrival rate at which the event arrives in the event arrival rate table storage unit 260, associated with each other (step A210 in FIG. 4A).

The occurrence probability calculation unit 103, after referring to the value of the event arrival rate table storage unit 260, calculates an event occurrence probability during the fixed time period W (sec) for each event stored in the event arrival rate table storage unit 260, in accordance with the above processing. The occurrence probability calculation unit 103 then stores the calculated value in the occurrence probability table storage unit 280 (step A220).

The event type window division unit 210 classifies events to the event type window in a unit of the fixed time period W (sec), based on the value stored in the event history DB storage unit 130. The event type window division unit 210 then stores the classified event type window, and the event type and the window, associated with each other, in the event type window table storage unit 220 (step A110 in FIG. 4A). The processing flow from the step A210 to the step A220 and the processing of the step A110 may be performed parallelly, or either of the two types of processing may be performed first. Since the steps A210, A220, and A110 are the same as the above procedures illustrated in FIG. 2, redundant explanation is omitted.

After completion of the steps A220 and A110, the rule generation unit 230 sets the number of events to be combined to 2 (step B120). The combination generation unit 410 then generates an event combination as described above, for the number of events to be combined specified by the rule generation unit 230, based on the value of the event type window table storage unit 220. The rule generation unit 230 then stores the generated event combination in the event combination storage unit 420 (step B130).

The combination generation unit 410 combines two kinds of event types when the rule generation unit 230 set the number of events to be combined to 2. The combination generation unit 410 generates the event combinations by combining all of the event types.

After completion of processing of the step B170, the rule generation unit 230 increases the number of events to be combined by 1. The combination generation unit 410 generates an event combination in accordance with the number of events to be combined specified by the rule generation unit 230, and stores the generated event combination in the event combination storage unit 420.

The minimum supporting rate calculation unit 430 then refers to the value held by the occurrence probability table storage unit 280 and the value held by the assumed erroneous detection rate storage unit 120, for each event combination stored in the event combination storage unit 420. The minimum supporting rate calculation unit 430 calculates the minimum supporting rate, based on the referred values, in accordance with the processing method represented by the Eqn. 9, and stores the calculated value in the minimum supporting rate storage unit 440 (step B140).

The combination selection unit 450 then calculates the supporting rate SR for the event combination. The combination selection unit 450 compares the calculated supporting rate SR with the value stored in the minimum supporting rate storage unit 440 for large and small. After that, the combination selection unit 450 only retains an event combination in which the calculated supporting rate SR value is larger than the minimum supporting rate (step B150). When deciding that there exists a combination in which the calculated supporting rates SR is larger than the value stored in the minimum supporting rate storage unit 440 (YES in step B160), the combination selection unit 450 performs the following processing. Specifically, the combination selection unit 450 temporarily stores an event combination in which the supporting rate SR is larger as described above, inside the combination selection unit 450.

The combination selection unit 450 then increases the number of event combinations by 1 (step B170), and adds one event to the event combination temporarily stored inside the combination selection unit 450, and thereafter the process returns to the step B130.

When deciding that the calculated respective supporting rate SR is smaller than the value stored in the minimum supporting rate storage unit 440 (NO in step B160), the combination selection unit 450 performs the following processing. Specifically, the combination selection unit 450 refers to the event combination temporarily stored inside the combination selection unit 450, and the dependency rule generation unit 460 generates a dependency rule (step B210).

The minimum reliability rate calculation unit 480 refers to the value stored in the occurrence probability table storage unit 280 and the value stored in the assumed erroneous detection rate storage unit 120, calculates the minimum reliability rate for each dependency rule generated by the dependency rule generation unit 460, and stores the calculated value in the minimum reliability rate storage unit 490 (step B220).

The dependency rule selection unit 510 calculates the reliability rate TR for each dependency rule generated by the dependency rule generation unit 460. The dependency rule selection unit 510 compares the calculated reliability rate TR with the value stored in the minimum reliability rate storage unit 490, associated with the dependency rule for large and small. The dependency rule selection unit 510 only retains a dependency rule in which the calculated reliability rate TR is larger than the value of the minimum reliability rate, among the dependency rules generated by the dependency rule generation unit 460 (step B230).

The dependency rule selection unit 510 then generates an event association rule for the above extracted dependency rule (step B240), and stores the generated event association rule in the event association rule storage unit 170.

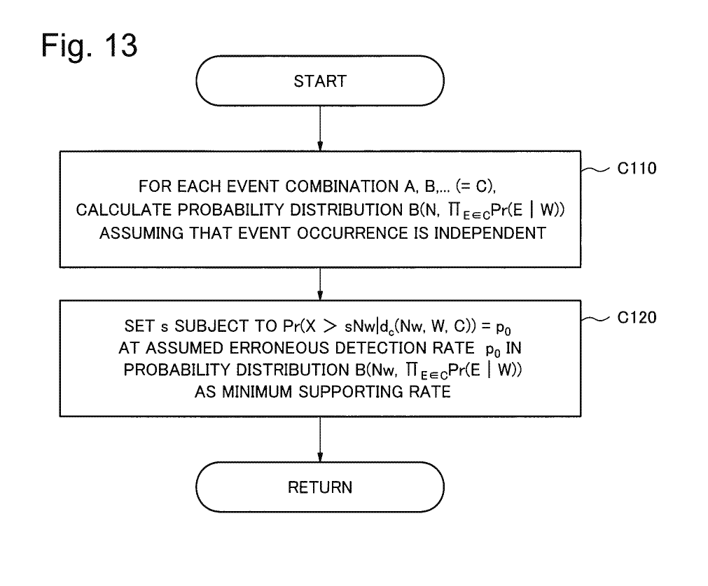

The following describes an operation of the minimum supporting rate calculation unit 430 with reference to the block diagram of FIG. 12 and the flowchart of FIG. 13. FIG. 12 is a block diagram illustrating a configuration of the minimum supporting rate calculation unit in the second exemplary embodiment of the present invention. FIG. 13 is a flowchart regarding processing performed by the minimum supporting rate calculation unit in the second exemplary embodiment of the present invention.

The probability distribution calculation unit 610 calculates a probability distribution dC(Nw, W, C) assuming that events occur independently of each other, for each event type combination “A, B, . . . ”(=C), in accordance with a following calculation method based on binomial distribution as follows (step C110). After that, the probability distribution calculation unit 610 stores the calculated value in the probability distribution storage unit 620. The probability distribution calculation unit 610 performs the calculation method in accordance with the value of Pr(|E|>0|W), and accordingly with the procedure represented by Eqn. 10:

dC(Nw,W,C)=B(Nw,ΠEεC_{—}Pr(|E|>0|W)) (Eqn. 10)

(where ΠEεC_Pr(|E|>0|W) represents multiplying all of the event types that pertain to the above event type combination C by Pr(|E|>0|W), and B(Nw, P) is a binomial distribution, accordingly, B(Nw, P)=Σi_C(Nw, i)×P↑i×(1−P)↑i, where C(Nw, i) represents the number of combinations when i combinations are taken out of Nw combinations, and P↑i represents exponentiation. Specifically P↑i represents 1 multiplied by W i times.)

Σi_{—}C(Nw,i)×P↑i×(1−P)↑i represents obtaining a total sum of C(Nw,i)×P↑i×(1−P)↑i for i.)

The distribution probability inverse calculation unit 630 calculates a largest s that satisfies “Pr(X>s×Nw|dC(Nw, W, C)) the assumed erroneous detection rate p0” for each event combination described above, in accordance with the probability distribution dC(Nw, W, C) calculated by the probability distribution calculation unit 610. The distribution probability inverse calculation unit 630 stores the calculated value in the minimum supporting rate storage unit 440 (step C120). It is noted that Pr(X>s×Nw|dC(Nw, W, C)) indicates a probability of a probability variable X taking a value larger than s×Nw in the probability distribution indicated by dC(Nw, W, C).

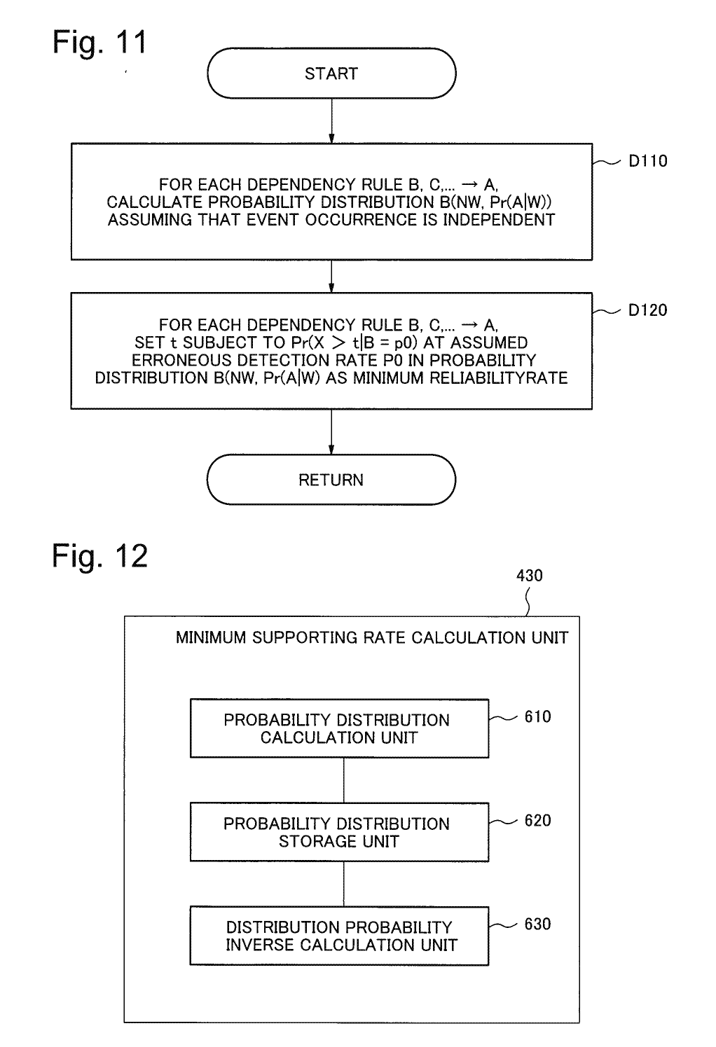

The following describes an operation of the minimum reliability rate calculation unit 480 in this exemplary embodiment with reference to the block diagram of FIG. 10 and the flowchart of FIG. 11. FIG. 10 is a block diagram illustrating a configuration of the minimum reliability rate calculation unit 480 in the second exemplary embodiment of the present invention. FIG. 11 is a flowchart regarding processing performed by the minimum reliability rate calculation unit 480 in the second exemplary embodiment of the present invention.

The probability distribution calculation unit 710 calculates the probability distribution dR(Nw, W, R) assuming that an event A occurs independently of events B, C, . . . for each dependency rule “B, C, . . . [symbol] A” stored in the dependency rule storage unit 470, in accordance with the following method. The method of calculation is a method calculating the binomial distribution B(Nw, Pr(A|W)) in accordance with the values of Nw and Pr(A|W). The probability distribution calculation unit 710 stores the calculated value in the probability distribution storage unit 720 (step D110). The dependency rule does not need to be necessarily “B, C, . . . [symbol] A” as described above.

The distribution probability inverse calculation unit 730 calculates a lowest t that satisfies “Pr(X>t|dR(Nw, W, R)) the assumed erroneous detection rate p0” for each dependency rule “B, C, . . . [symbol] A” as described above, in the probability distribution dR(Nw, W, R) calculated by the probability distribution calculation unit 710. The distribution probability inverse calculation unit 730 stores the calculated value in the minimum reliability rate storage unit 490 (step C130). By calculation in accordance with the above method, the distribution probability inverse calculation unit 730 calculates the lowest t, as the minimum reliability rate, that satisfies a condition that the probability that X>t is equal to or less than p0 in the above probability distribution dR(Nw, W, R).

This exemplary embodiment relies on assumptions regarding the event occurrence distribution probability that is input and the association among the respective events in order to make it possible to evaluate the minimum supporting rate and the minimum reliability rate. Specifically, it is assumed that the event occurrence distribution probability follows the Poisson distribution. It is also assumed that occurrence of the respective events is stochastically independent of each other.

As such, in this exemplary embodiment, the calculation is performed in accordance with the above-described calculation method. Therefore, it is made possible to ensure that the thresholds (that is, the minimum supporting rate and the minimum reliability rate) calculated by this exemplary embodiment do not exceed the allowable erroneous detection rate.

The following describes an operation of this exemplary embodiment of the present invention by using a specific example.

FIG. 26 is a diagram schematically illustrating an example of information stored in the event history DB storage unit 130. The event history DB is also used by the event correlation detection system in the second exemplary embodiment of the present invention. The table stored in the event history DB storage unit 130 associates an ID(E#) of an event, a time at which the event occurs (TIME), the event type, and the like with each other. The table stored in the event history DB storage unit 130 may be associated with any items other than the above, and may not need to include all of the above items. When all the event numbers (E#) existing in the event history DB illustrated in FIG. 26 are referred to, the event types associated with the respective E# are the following four event types:

QueryError,

DBError,

NWCongestion, and

TooManyRequest.

The arrival rate calculation unit 102 refers to the value stored in the event history DB storage unit 130 and retrieves one event therefrom. The arrival rate calculation unit 102 then calculates an arrival rate for the retrieved event in accordance with the above method, associates the calculated value with the event type, and stores the arrival rate in the event arrival rate table storage unit 260. The arrival rate calculation unit 102 performs such processing for all of the events stored in the event history DB storage unit 130 (step A210 in FIG. 4A).

FIG. 19 is a diagram illustrating an exemplary reference table indicating association between the event type and the arrival rate that are stored in the event arrival rate table storage unit 260 in the second exemplary embodiment of the present invention. The event arrival rate table associates the event type with the calculated arrival rate. It is assumed that events having the QueryError type occur 48 times during 3 hours and 20 minutes from the time “2011 Nov. 23 10:00:00” to the time “2011 Nov. 23 13:20,” that is, in 12,000 seconds. In this case, the arrival rate calculation unit 102 calculates an occurrence rate of the QueryError type events as XQueryError=48÷12000=0.004 (/sec).

The occurrence probability calculation unit 103 then refers to the event arrival rate table storage unit 260, calculates an event occurrence probability during the fixed time period W (sec) for each event as follows, and stores the calculated value in the occurrence probability table storage unit 280 (step A220).

When W=300 (/sec), for example, the occurrence probability calculation unit 103 calculates a probability of occurrence of the QueryError type event as 0.698806 in accordance with Eqn. 4. The value 0.698806 is calculated in accordance with the following equation:

Pr(|QueryError|>0|W)=1−exp(−λQueryError×W)=1−exp(−0.004×300)=0.698806.

The occurrence probability calculation unit 103 then stores the calculated value and the event type, associated with each other, in the occurrence probability table storage unit 280 as illustrated in FIG. 16. FIG. 16 is a diagram illustrating an exemplary reference table indicating association between the event type and the occurrence probability that are stored in the occurrence probability table storage unit 280 in the second exemplary embodiment of the present invention.

The event type window division unit 210 divides time into fixed time periods W (sec). It is noted that this divided individual unit of time is called a window. The event type window division unit 210 searches the event history DB storage unit 130 for an event that occurs in the window. The event type window division unit 210 stores the event type of the event and the window, associated with each other, in the event type window table storage unit 220 (step A110 in FIG. 4A).

The rule generation unit 230 operates as follows. After completion of the steps A220 and A110, the rule generation unit 230 sets the initial number of event combinations to 2 (step B120). The combination generation unit 410 refers to the value stored in the event type window table storage unit 220, and generates an event combination that includes events in accordance with the number of events to be combined specified by the rule generation unit 230 (step B130). Accordingly, at the initial stage, the combination generation unit 410 combines two kinds of events.

There are four kinds of event types in the event type window table in FIG. 25. When the rule generation unit 230 sets the number of event types to be combined to 2, the combination generation unit 410 generates the following six kinds of event combinations:

QueryError, DBError;

QueryError, NWCongestion;

QueryError, TooManyRequest;

DBError, NWCongestion;

DBError, TooManyRequest; and

NWCongestion, TooManyRequest.

The minimum supporting rate calculation unit 430 refers to the table in the occurrence probability table storage unit 280 and the value stored in the assumed erroneous detection rate storage unit 120, and calculates the minimum supporting rate, for each of the event combinations, in accordance with the following exemplary processing method. The minimum supporting rate calculation unit 430 stores the calculated minimum supporting rate in the minimum supporting rate storage unit 440 (step B140).

Specifically, the minimum supporting rate calculation unit 430 performs processing as follows. It is assumed in this example that the assumed erroneous detection rate storage unit 120 stores a value of 0.1. The following describes an operation of the minimum supporting rate calculation unit 430, as an example, for a case that the minimum supporting rate is calculated in case of the event type combination including an event having the QueryError type and an event having the DBError type.

The minimum supporting rate calculation unit 430 performs calculation assuming that occurrence of an event having the QueryError type and an event having the DBError type is stochastically independent of each other. Specifically, the minimum supporting rate calculation unit 430 calculates a probability of concurrence of the above events in the window during the fixed time period W (sec) in accordance with the following processing.

P(QueryError&DBError|W)=P(QueryError|W)×P(DBError|W)=0.698806×0.259182=0.181118.

The minimum supporting rate calculation unit 430 then calculates min{s|Pr(X>Nws|B(Nw, P(QueryError&DBError|W)))>p0} based on the calculated probability P(QueryError&DBError|W), and sets the calculated value as the minimum supporting rate. It is noted that X in the above equation is a probability variable indicating the number of windows in which the QueryError and the DBError occur. It is also noted that the above equation represents calculating the lowest s that satisfies: Pr(X>Nws|B(Nw, P(QueryError&DBError|W)))>p0.

The combination selection unit 450 then calculates the supporting rate SR of the event combination in accordance with the following exemplary method. For example, it is assumed that the number of windows in which the QueryError and the DBError occur is 10 times out of the total number of the windows Nw=40 times. In this case, the combination selection unit 450 calculates the supporting rate SR as 10÷40=0.25 and outputs the value.

The combination selection unit 450 then compares the calculated supporting rate SR of each event combination with the value of the minimum supporting rate associated with the combination. After that, the combination selection unit 450 only retains event combinations in which the calculated supporting rate SR is larger than the value of the minimum supporting rate (step B150).

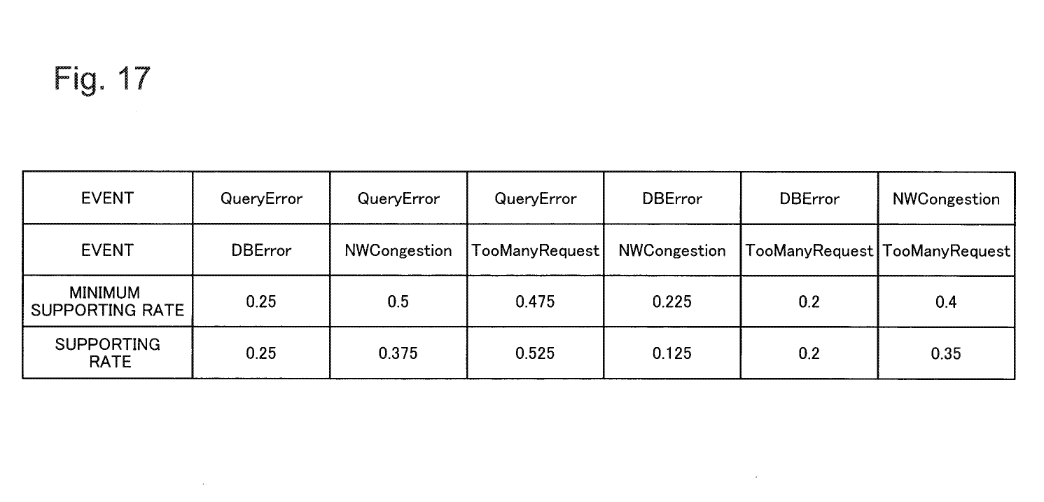

FIG. 17 illustrates an exemplary table in which the combination of two kinds of events as described above is associated with the supporting rate SR calculated in the combination and the minimum supporting rate. The table of FIG. 17 indicates the calculated supporting rate SR and the like for the above six kinds of the event type combinations.

The rule generation unit 230 recognizes that there exists an event type combination having the supporting rate SR larger than the value of the minimum supporting rate. The event type combination having the calculated supporting rate SR larger than the value of the minimum supporting rate in the table of FIG. 17 is only the event type combination of the QueryError type and the TooManyRequest type. The values of the supporting rate SR for the other event type combinations are smaller than the value of the minimum supporting rate. Therefore, the combination selection unit 450 extracts the event type combination that combined the QueryError type and the TooManyRequest type.

The rule generation unit 230 then increases the length of the event type combination by 1 (step B170). Specifically, in this example, since the length of the event type combination is 3, the combination generation unit 410 generates a combination of three events in accordance with the value of 3 specified by the rule generation unit 230, and stores the result in the event combination storage unit 420. In this example, the event combination storage unit 420 generates the following event type combinations for the combination of the event types as described above.

QueryError, TooManyRequest, NWCongestion; and

QueryError, TooManyRequest, DBError.

The minimum supporting rate calculation unit 430 then calculates the minimum supporting rate for each of the two kinds of event combinations in accordance with the above method (step B149). The combination selection unit 450 calculates the supporting rate SR for the event type combination and compares the calculated value of the supporting rate SR with the value stored in the minimum supporting rate storage unit 440 for large and small. As described above, the combination selection unit 450 only retains event type combinations in which the calculated supporting rate SR is larger than the value of the minimum supporting rate (step B150).

It is assumed that the respective supporting rate SR for the two kinds of event type combinations described above is smaller than the minimum supporting rate. As illustrated in FIG. 17, the event type combination including an event having the QueryError type and an event having the TooManyRequest type in which the calculated supporting rate SR is larger than the minimum supporting rate becomes a target of processing in the dependency rule generation unit 460.

The dependency rule generation unit 460 refers to the value stored in the event combination storage unit 420 and thus reads the values of “QueryError” and “TooManyRequest.” The dependency rule generation unit 460 then performs processing as follows and generates a dependency rule (step B210).

In this example, there are the following two kinds of dependency rules if the event type combination including an event having the QueryError type and an event having the TooManyRequest type that is retained by the combination selection unit 450:

QueryError [symbol] TooManyRequest,

TooManyRequest [symbol] QueryError.

The minimum reliability rate calculation unit 480 refers to the value stored in the occurrence probability table storage unit 280 and the value stored in the assumed erroneous detection rate storage unit 120, performs the following processing, and thus calculates the minimum reliability rate, for each of the dependency rules. The minimum reliability rate calculation unit 480 stores the calculated value in the minimum reliability rate storage unit 490 (step B220).

For example, it is assumed that the number of times of occurrence of the events having the QueryError type is 32 times. Further, it is assumed that the number of windows in which an event having the QueryError type and an event having the TooManyRequest type occur is 21 times.

In the case of the dependency rule of “QueryError [symbol] TooManyRequest,” the minimum reliability rate calculation unit 480 calculates Pr(TooManyRequest|W)=21÷32=0.65625, and sets the value as the value of the minimum reliability rate. The dependency rule selection unit 510 then calculates the reliability rate TR for each of the dependency rules. After that, the dependency rule selection unit 510 compares the calculated reliability rate TR with the value associated with the dependency rule in the minimum reliability rate storage unit 490. The dependency rule selection unit 510 only retains, based on the result of the comparison, dependency rules in which the calculated reliability rate TR is larger than the value of the minimum reliability rate (step B230).

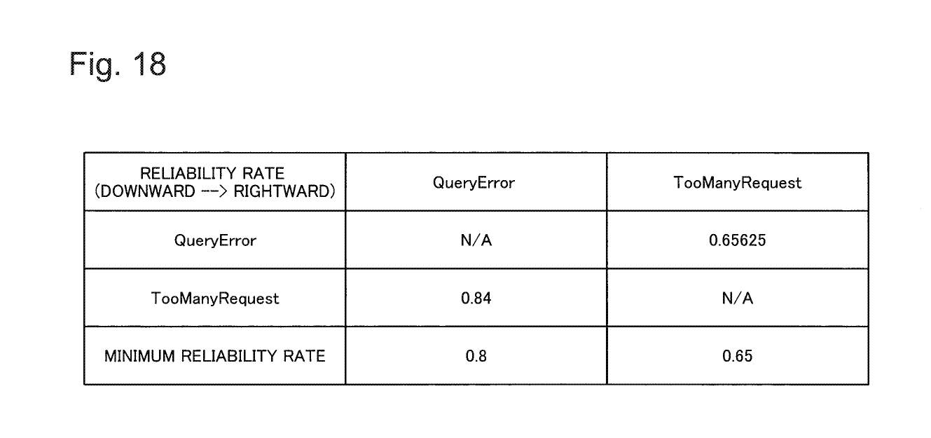

FIG. 18 is a diagram illustrating an example of the minimum reliability rate and the reliability rate TR in the second exemplary embodiment of the present invention. The leftmost column in FIG. 18 indicates A in the dependency rule “A [symbol] B,” and the uppermost row in FIG. 18 indicates B in the dependency rule “A [symbol] B.” In FIG. 18, a value appearing in the field where the row indicating A and the column indicating B intersect indicates a value of the reliability rate TR calculated for the dependency rule “A [symbol] B.”

Referring to FIG. 18, it can be appreciated that the reliability rate TR for the dependency rule “QueryError [symbol] TooManyRequest” is 0.65625, and the reliability rate TR for the dependency rule “TooManyRequest [symbol] QueryError” is 0.84.

The lowermost row of FIG. 18 associates the value of the minimum reliability rate for the dependency rule “A [symbol] B” with the column that indicates B. Since the minimum reliability rate for the dependency rule “TooManyRequest [symbol] QueryError” is 0.8, the calculated reliability rate TR of 0.84 is larger than the minimum reliability rate. Likewise, since the minimum reliability rate for the dependency rule “QueryError [symbol] TooManyRequest” is 0.65, the calculated reliability rate TR of 0.65625 is larger than the minimum reliability rate.

Therefore, the dependency rule selection unit 510 sets both of the above two dependency rules to be the event association rules in accordance with the comparison results as described above. The dependency rule selection unit 510 stores the two dependency rules in the event association rule storage unit 170 (step B240).

FIG. 9 is a flowchart regarding the event correlation detection procedure in the second exemplary embodiment of the present invention. The following describes the event correlation detection procedure by using a specific example with reference to FIG. 9.

The window division unit 140 receives an event caused by the event source (for example, the event source 110 in FIG. 21). The window division unit 140 classifies events in accordance with the occurrence time in each fixed time period W. The window division unit 140 associates the divided windows with an event that occurs in the window, and the like, and stores the result in the event type window table storage unit 220 (step E110).

FIG. 24 is a diagram illustrating a specific example of the event window table. In FIG. 24, it is appreciated that the TooManyRequest type associated with the event (E#=2343) that occurs in the window 1(W#=1) and the QueryError type associated with the event (E#=2345) occur in the same window. This situation corresponds to the generated event association rule “TooManyRequest [symbol] QueryError.”

The event association rule engine unit 160 selects events having an association among the events stored in the event type window table storage unit 220 in accordance with the generated event association rule “TooManyRequest [symbol] QueryError.” In this example, the events having an association are E#=2343 and E#=2345.

Accordingly, the exemplary embodiment of the present invention makes it possible to reduce the erroneous detection rate to an allowable level.

### (Exemplary Hardware Configuration)

FIG. 20 is a block diagram schematically illustrating a hardware configuration of a computer processing apparatus that can implement the event correlation detection system according to the exemplary embodiments of the present invention.

The following describes an exemplary configuration of hardware resources for implementing the event correlation detection system in the above-described exemplary embodiments using a single computer processing apparatus (information processing apparatus, or a computer). It should be noted, however, that the event correlation detection system may be implemented using at least two types, either physical or functional, of computer processing apparatuses. In addition, the event correlation detection system may be implemented in the form of a dedicated apparatus.

FIG. 20 is the block diagram schematically illustrating the hardware configuration of a computer processing apparatus that can implement the event correlation detection system according to the first or second exemplary embodiment. The computer processing apparatus 2306 includes a central processing unit (CPU) 2301, a memory unit 2302, a disk 2303, an output apparatus 2304, an input apparatus 2305, and a non-volatile recording medium 2307 (which may be hereafter referred to as “recording medium”).

The non-volatile recording medium 2307 may be any medium that can be read by a computer. The non-volatile recording medium 2307 is, for example, a portable medium that is capable of retaining a relevant program in the absence of power supply. For example, the examples of the non-volatile recording medium 2307 may include the following media:

compact disc;

digital versatile disc (DVD);

Blu-ray disc; and

universal serial bus (USB) memory unit.

The above media is portable and capable of retaining such a program without power supply.
The non-volatile recording medium 2307 is not limited to the above-mentioned media. In place of the non-volatile recording medium 2307, such a program may be carried via a communications network.

When executing the software program (computer program: hereafter simply referred to as a “program”) stored in the disk 2303, the distribution probability inverse calculation unit 730 copies the program into the memory unit 2302 and performs arithmetic processing. The distribution probability inverse calculation unit 730 reads data necessary for execution of the program from the memory unit 2302. The distribution probability inverse calculation unit 730 displays the output result on the output apparatus 2304 when necessary. When the program is externally loaded, the distribution probability inverse calculation unit 730 reads the program from the input apparatus 2305. The distribution probability inverse calculation unit 730 interprets the event correlation detection program in the memory unit 2302 and executes the program. The distribution probability inverse calculation unit 730 performs the processing in a sequence in accordance with the flowcharts (FIGS. 2, 4A, 4B, 9, 11, and 13) and equations, which have been referred in the above-described exemplary embodiments.

Accordingly, in such a case, it can be appreciated that the present invention may be implemented by the event correlation detection program. It can further be appreciated that the present invention may be implemented by a computer-readable recording medium storing the event correlation detection program.

It should be noted that all or part of the above-described exemplary embodiments may be described in such a manner as defined in the following supplementary notes. However, the present invention that has been described in the exemplary embodiments is not limited to the following supplementary notes.

### (Supplementary Note 1)

An event correlation detection system that includes, for a plurality of event types:

an arrival rate calculation unit that calculates, for each of the event types, an arrival rate that the event type arrives during a predetermined time period;

an occurrence probability calculation unit that calculates, for each of the event types, a first probability that the event type occurs, based on the arrival rate and the predetermined time period;

a threshold calculation unit that calculates a second probability that the plurality of event types occur, based on the first probability, and calculates a minimum supporting rate for a combination of event types and a minimum reliability rate for a dependency rule, based on the second probability; and

an event association rule engine unit that detects an association among the plurality of event types in accordance with the minimum supporting rate and the minimum reliability rate.

### (Supplementary Note 2)

The event correlation detection system defined in Supplementary note 1 further including a window division unit that classifies the event types in the respective predetermined time period, associating the respective predetermined time period with a set of the classified event types, and generates a window,

wherein the arrival rate calculation unit performs calculation in accordance with the window.

### (Supplementary Note 3)

The event correlation detection system defined in Supplementary note 2, further including:

a combination generation unit that generates a group of the plurality of event types residing in the window, gathers the groups, and thereby generates a first combination;

a combination selection unit that calculates a supporting rate indicating a ratio of a number of the windows in which all the event types residing in the group pertaining to the first combination appear, to a number of all the windows, and selecting, among the first combination, the specific group for which the supporting rate takes a value larger than the minimum supporting rate, as a second combination;

a dependency rule generation unit that generates a dependency rule that includes a consequent, corresponding to one event type among event types in a group residing in the second combination, and an antecedent, corresponding to remaining event types; and

a dependency rule selection unit that calculates a reliability rate indicating a ratio of a number of windows in which the event types appearing in the dependency rule appear, to a number of the windows in which the antecedent appears,

wherein the event association rule engine unit detects an association among the event types based on magnitude of the reliability rate and the minimum reliability rate.

### (Supplementary Note 4)

The event correlation detection system defined in Supplementary note 3,

wherein the combination generation unit specifies a combination number to be two;

the combination generation unit performs a first process for generating the group by combining the combination number of the event types;

the event association rule engine unit performs a second process for retaining the second combination as a third combination when deciding that there exists a group for which the reliability rate is larger than the minimum reliability rate, and then performs a third process for increasing the combination number by one;

the event association rule engine unit repeats the first to third processes in sequence until deciding that there exists no group for which the reliability rate is larger than the minimum reliability rate; and

the event association rule engine unit outputs the specific third combination last retained by the event association rule engine unit, when deciding that there exists no group for which the reliability rate is larger than the minimum reliability rate.

### (Supplementary Note 5)

The event correlation detection system defined in Supplementary note 2, wherein the threshold calculation unit includes:

a probability distribution calculation unit that calculates the second probability based on the first probability, gathers calculated values, and thereby generates a probability distribution G(i) (where i is a natural number); and

a distribution probability calculation unit that obtains, in the probability distribution G(i), a total sum of G(i) for a value of i equal to or larger than a specific value, and outputs the specific value that is a lowest within a range in which a product of the obtained total sum and the total number of windows is equal to or lower than a predetermined assumed erroneous detection rate.

### (Supplementary Note 6)

The event correlation detection system defined in Supplementary note 2, wherein the threshold calculation unit calculates Pr(|E|>0|W) representing the first probability in accordance with a process of

Pr(|E|>0|W)=1−exp(−λE×W)

(where W is a time period in the window, λE=NE÷T, exp( ) is an exponential function, T is a time period, NE is a number of times of occurrence of an event type E during a time period T, |E| is a number of times of occurrence of events having an event type E, and Pr(|E|>0|W) is a probability of occurrence of events having an event type E during a time period W in the window);
calculates the second probability based on the first probability; and
calculates the minimum supporting rate based on the second probability.

### (Supplementary Note 7)

The event correlation detection system defined in Supplementary note 2, wherein the threshold calculation unit calculates Pr(R|W) representing the first probability in accordance with a process of

Pr(R|W)=Pr(|A|>0|W)

(where R is a dependency rule, A is the consequent in the dependency rule, W is a time period in the window, |A| is a number of times of occurrence of events having an event type A, Pr(|A|>0|W) is a probability of occurrence of at least one event having an event type A during a time period W in the window, and Pr(R|W) is a probability of “occurrence of a dependency rule R during a time period W in the window”); calculates the second probability based on the first probability; and calculates the minimum reliability rate based on the second probability.

### (Supplementary Note 8)

The event correlation detection system defined in Supplementary note 5, wherein the threshold calculation unit calculates the probability distribution in accordance with calculation processing of a binomial distribution with the number of time periods existing in the window and the first probability, and calculates the minimum supporting rate based on the probability distribution.

### (Supplementary Note 9)

The event correlation detection system defined in Supplementary note 5, wherein the threshold calculation unit calculates the probability distribution in accordance with calculation processing of a binomial distribution with the number of time periods existing in the window and the first probability, and calculates the minimum reliability rate based on the probability distribution.

### (Supplementary Note 10)

The event correlation detection system defined in Supplementary note 5, wherein the threshold calculation unit calculates a lowest s satisfying (Σi>s_Nw×G(i))<p0 (where Nw is a total number of the windows, G(i) is the probability distribution calculated based on the λE, (Σi>s_Nw×G(i)) is a total sum of Nw×G(i) for i larger than t, p0 is the assumed erroneous detection rate, and i is a natural number); and

specifies the calculated value as the minimum supporting rate.

### (Supplementary Note 11)

The event correlation detection system defined in Supplementary note 5, wherein the threshold calculation unit calculates a lowest t satisfying (Σi>t_Nw×dR(Nw, W, R)(i))<p0

(where Nw is a total number of the windows, dR(Nw, W, R)(i) is the probability distribution calculated based on the dependency rule R, (Σi>t_Nw×dR(Nw, W, R)(i)) is a total sum of Nw×dR(Nw, W, R)(i) for i larger than t, p0 is the assumed erroneous detection rate, and i is a natural number); and
specifies the calculated value as the minimum reliability rate.

### (Supplementary Note 12)

An event correlation detection method including, for a plurality of event types:

calculating, for each of the event types, an arrival rate that the event type arrives during a predetermined time period;

calculating, for each of the event types, a first probability that the event type occurs, based on the arrival rate and the time period;

calculating a second probability that the plurality of event types occur, based on the first probability and calculating a minimum supporting rate for an event type combination and a minimum reliability rate for a dependency rule, based on the second probability; and

detecting an association among the plurality of event types in accordance with the minimum supporting rate and the minimum reliability rate.

### (Supplementary Note 13)

A computer program causing a computer to implement functions including, for a plurality of event types:

an arrival rate function that calculates, for each of the event types, an arrival rate that the event type arrives during a predetermined time period;

an occurrence probability calculation function that calculates, for each of the event types, a first probability that the event type occurs based on the arrival rate and the time period;

a threshold calculation function that calculates a second probability that the plurality of event types occur, based on the first probability, and calculating a minimum supporting rate for an event type combination and a minimum reliability rate for a dependency rule, based on the second probability; and

an event association rule engine function that detects an association among the plurality of event types in accordance with the minimum supporting rate and the minimum reliability rate.

The present invention has been described by discussing the above exemplary embodiments as illustration of the exemplary configurations of the present invention. However, the present invention is in no way limited to the above-mentioned exemplary embodiments. Accordingly, various exemplary embodiments of the invention, which may be understood by those skilled in the art, can be constructed within the scope of the present invention.

This application is based upon and claims the benefit of priority from the Japanese Patent Application No. 2012-068639, filed Mar. 26, 2012, the disclosure of which is incorporated herein in its entirety.

### REFERENCE SIGNS LIST

16 Mining kernel function
Mining kernel interface function
Mining result recording function
101 Event correlation detection system
102 Arrival rate calculation unit
103 Occurrence probability calculation unit
104 Threshold calculation unit
105 Event correlation detection system
110 Event source
115 Graphical user interface (GUI)
120 Assumed erroneous detection rate storage unit
130 Event history DB storage unit
140 Window division unit
150 Event type window table storage unit
160 Event association rule engine unit
170 Event association rule storage unit
210 Event type window division unit
220 Event type window table storage unit
230 Rule generation unit
240 Rule candidate storage unit
260 Event arrival rate table storage unit
280 Occurrence probability table storage unit
310 Threshold storage unit
410 Combination generation unit
420 Event combination storage unit
430 Minimum supporting rate calculation unit
440 Minimum supporting rate storage unit
450 Combination selection unit
460 Dependency rule generation unit
470 Dependency rule storage unit
480 Minimum reliability rate calculation unit
490 Minimum reliability rate storage unit
510 Dependency rule selection unit
610 Probability distribution calculation unit
620 Probability distribution storage unit
630 Distribution probability inverse calculation unit
710 Probability distribution calculation unit
720 Probability distribution storage unit
730 Distribution probability inverse calculation unit
2301 Central processing unit (CPU)
2302 Memory unit
2303 Disk
2304 Output apparatus
2305 Input apparatus
2306 Computer processing apparatus
2307 Non-volatile recording medium
1001 Window division unit
1002 Event type window division unit
1003 Event association rule engine unit
1004 Event history database (DB) storage unit
1005 Event type window division unit
1006 Event type window table storage unit
930 Rule generation unit
1008 Event association rule storage unit

1. An event correlation detection system that comprising, for a plurality of event types:
an arrival rate calculation unit that calculates, for each of the event types, an arrival rate that the event type arrives during a predetermined time period;
an occurrence probability calculation unit that calculates, for each of the event types, a first probability that the event type occurs, based on the arrival rate and the predetermined time period;
a threshold calculation unit that calculates a second probability that the plurality of event types occur, based on the first probability, and calculates a minimum supporting rate for a combination of event types and a minimum reliability rate for a dependency rule, based on the second probability; and
an event association rule engine unit that detects an association among the plurality of event types in accordance with the minimum supporting rate and the minimum reliability rate.

2. The event correlation detection system according to claim 1 further comprising a window division unit that classifies the event types in the respective predetermined time period, associating the respective predetermined time period with a set of the classified event types, and generates a window,
wherein the arrival rate calculation unit performs calculation in accordance with the window.

3. The event correlation detection system according to claim 2, further comprising
a combination generation unit that generates a group of the plurality of event types residing in the window, gathers the groups, and thereby generates a first combination;
a combination selection unit that calculates a supporting rate indicating a ratio of a number of the windows in which all the event types residing in the group pertaining to the first combination appear, to a number of all the windows, and selecting, among the first combination, the specific group for which the supporting rate takes a value larger than the minimum supporting rate, as a second combination;
a dependency rule generation unit that generates a dependency rule that includes a consequent, corresponding to one event type among event types in a group residing in the second combination, and an antecedent, corresponding to remaining event types; and
a dependency rule selection unit that calculates a reliability rate indicating a ratio of a number of windows in which the event types appearing in the dependency rule appear, to a number of the windows in which the antecedent appears,
wherein the event association rule engine unit detects an association among the event types based on magnitude of the reliability rate and the minimum reliability rate.

4. The event correlation detection system according to claim 3,
wherein the combination generation unit specifies a combination number to be two;
the combination generation unit performs a first process for generating the group by combining the combination number of the event types;
the event association rule engine unit performs a second process for retaining the second combination as a third combination when deciding that there exists a group for which the reliability rate is larger than the minimum reliability rate, and then performs a third process for increasing the combination number by one;
the event association rule engine unit repeats the first to third processes in sequence until deciding that there exists no group for which the reliability rate is larger than the minimum reliability rate; and
the event association rule engine unit outputs the specific third combination last retained by the event association rule engine unit, when deciding that there exists no group for which the reliability rate is larger than the minimum reliability rate.

5. The event correlation detection system according to claim 2, wherein the threshold calculation unit includes:
a probability distribution calculation unit that calculates the second probability based on the first probability, gathers calculated values, and thereby generates a probability distribution G(i) (where i is a natural number); and
a distribution probability calculation unit that obtains, in the probability distribution G(i), a total sum of G(i) for a value of i equal to or larger than a specific value, and outputs the specific value that is a lowest within a range in which a product of the obtained total sum and the total number of windows is equal to or lower than a predetermined assumed erroneous detection rate.

6. The event correlation detection system according to claim 2, wherein the threshold calculation unit calculates Pr(|E|>0|W) representing the first probability in accordance with a process of
Pr(|E|>0|W)=1−exp(−E×W)
(where W is a time period in the window, E=NE÷T, exp( ) is an exponential function, T is a time period, NE is a number of times of occurrence of an event type E during a time period T, |E| is a number of times of occurrence of events having an event type E, and Pr(|E|>0|W) is a probability of occurrence of events having an event type E during a time period W in the window);
calculates the second probability based on the first probability; and
calculates the minimum supporting rate based on the second probability.

7. The event correlation detection system according to claim 2, wherein the threshold calculation unit calculates Pr(R|W) representing the first probability in accordance with a process of
Pr(R|W)=Pr(|A|>0|W)
(where R is a dependency rule, A is the consequent in the dependency rule, W is a time period in the window, |A| is a number of times of occurrence of events having an event type A, Pr(|A|>0|W) is a probability of occurrence of at least one event having an event type A during a time period W in the window, and Pr(R|W) is a probability of “occurrence of a dependency rule R during a time period W in the window”);
calculates the second probability based on the first probability; and
calculates the minimum reliability rate based on the second probability.

8. The event correlation detection system according to claim 5, wherein the threshold calculation unit calculates the probability distribution in accordance with calculation processing of a binomial distribution with the number of time periods existing in the window and the first probability, and calculates the minimum supporting rate based on the probability distribution.

9. An event correlation detection method comprising, for a plurality of event types:
calculating, for each of the event types, an
arrival rate that the event type arrives during a predetermined time period;
calculating, for each of the event types, a first probability that the event type occurs, based on the arrival rate and the time period;
calculating a second probability that the plurality of event types occur, based on the first probability and calculating a minimum supporting rate for an event type combination and a minimum reliability rate for a dependency rule, based on the second probability; and
detecting an association among the plurality of event types in accordance with the minimum supporting rate and the minimum reliability rate.

10. A non-transitory computer readable media storing, a computer program causing a computer to implement functions comprising, for a plurality of event types:
an arrival rate function that calculates, for each of the event types, an arrival rate that the event type arrives during a predetermined time period;
an occurrence probability calculation function that calculates, for each of the event types, a first probability that the event type occurs based on the arrival rate and the time period;
a threshold calculation function that calculates a second probability that the plurality of event types occur, based on the first probability, and calculating a minimum supporting rate for an event type combination and a minimum reliability rate for a dependency rule, based on the second probability; and
an event association rule engine function that detects an association among the plurality of event types in accordance with the minimum supporting rate and the minimum reliability rate.

11. The event correlation detection system according to claim 5, wherein the threshold calculation unit calculates the probability distribution in accordance with calculation processing of a binomial distribution with the number of time periods existing in the window and the first probability, and calculates the minimum reliability rate based on the probability distribution.

12. The event correlation detection system according to claim 5, wherein the threshold calculation unit calculates a lowest s satisfying (Σi>s_Nw×G(i))<p0
(where Nw is a total number of the windows, G(i) is the probability distribution calculated based on the E, (Σi>s_Nw×G(i)) is a total sum of Nw×G(i) for i larger than t, p0 is the assumed erroneous detection rate, and i is a natural number); and
specifies the calculated value as the minimum supporting rate.

13. The event correlation detection system according to claim 5, wherein the threshold calculation unit calculates a lowest t satisfying (·i>t_Nw×dR(Nw, W, R)(i))<p0
(where Nw is a total number of the windows, dR(Nw, W, R)(i) is the probability distribution calculated based on the dependency rule R, (Σi>t_Nw×dR(Nw, W, R)(i)) is a total sum of Nw×dR(Nw, W, R)(i) for i larger than t, p0 is the assumed erroneous detection rate, and i is a natural number); and
specifies the calculated value as the minimum reliability rate.
